(19) United States
(12) Patent Application Publication
(10) Pub. No.: US 2017/0214744 A1
(43) Pub. Date: Jul. 27, 2017

(54) SYSTEMS AND METHODS FOR ADAPTING A NETWORK OF MOVING THINGS, FOR EXAMPLE INCLUDING AUTONOMOUS VEHICLES, BASED ON USER FEEDBACK

(71) Applicant: Veniam, Inc., Mountain View, CA (US)

(72) Inventors: Filipe Neves, Aguada de Baixo (PT); Diogo Carreira, Carriço (PT); Ricardo Matos, Porto (PT)

(21) Appl. No.: 15/377,636

(22) Filed: Dec. 13, 2016

Related U.S. Application Data
(60) Provisional application No. 62/286,243, filed on Jan. 22, 2016.

(51) Int. Cl. H04L 29/08

(52) U.S. Cl. CPC H04L 67/12; H04L 67/22; H04L 67/10; H04L 67/34; H04W 88/08

(57) ABSTRACT

Systems and methods for adapting a network of moving things, for example including autonomous vehicles, based at least in part on user feedback. As non-limiting examples, various aspects of this disclosure provide systems and methods for obtaining user feedback, communicating user feedback, analyzing obtained user feedback, and determining and implementing corrective action, for example in a real-time or delayed manner.

### CROSS-REFERENCE TO RELATED APPLICATIONS/INCORPORATION BY REFERENCE

This patent application makes reference to, claims priority to, and claims benefit from U.S. Provisional Patent Application Ser. No. 62/286,243, filed on Jan. 22, 2016, and titled “Systems and Methods for Adapting a Network of Moving Things Based on User Feedback,” which is hereby incorporated herein by reference in its entirety for all purposes.

This application is related to U.S. Provisional Application No. 62/260,749, filed on Nov. 30, 2015, and titled “Systems and Methods for Improving Fixed Access Point Coverage in a Network of Moving Things,” the entire contents of which are hereby incorporated herein by reference for all purposes. The present application is also related to U.S. Provisional Application Ser. No. 62/221,997, titled “Integrated Communication Network for a Network of Moving Things,” filed on Sep. 22, 2015; U.S. Provisional Application Ser. No. 62/222,016, titled “Systems and Methods for Synchronizing a Network of Moving Things,” filed on Sep. 22, 2015; U.S. Provisional Application Ser. No. 62/222,042, titled “Systems and Methods for Managing a Network of Moving Things,” filed on Sep. 22, 2015; U.S. Provisional Application Ser. No. 62/222,066, titled “Systems and Methods for Monitoring a Network of Moving Things,” filed on Sep. 22, 2015; U.S. Provisional Application Ser. No. 62/222,077, titled “Systems and Methods for Detecting and Classifying Anomalies in a Network of Moving Things,” filed on Sep. 22, 2015; U.S. Provisional Application Ser. No. 62/222,098, titled “Systems and Methods for Managing Mobility in a Network of Moving Things,” filed on Sep. 22, 2015; U.S. Provisional Application Ser. No. 62/222,121, titled “Systems and Methods for Managing Connectivity a Network of Moving Things,” filed on Sep. 22, 2015; U.S. Provisional Application Ser. No. 62/222,135, titled “Systems and Methods for Collecting Sensor Data in a Network of Moving Things,” filed on Sep. 22, 2015; U.S. Provisional Application Ser. No. 62/222,145, titled “Systems and Methods for Interfacing with a Network of Moving Things,” filed on Sep. 22, 2015; U.S. Provisional Application Ser. No. 62/222,150, titled “Systems and Methods for Interfacing with a User of a Network of Moving Things,” filed on Sep. 22, 2015; U.S. Provisional Application Ser. No. 62/222,168, titled “Systems and Methods for Data Storage and Processing for a Network of Moving Things,” filed on Sep. 22, 2015; U.S. Provisional Application Ser. No. 62/222,183, titled “Systems and Methods for Vehicle Traffic Management in a Network of Moving Things,” filed on Sep. 22, 2015; U.S. Provisional Application Ser. No. 62/222,186, titled “Systems and Methods for Environmental Management in a Network of Moving Things,” filed on Sep. 22, 2015; U.S. Provisional Application Ser. No. 62/222,190, titled “Systems and Methods for Port Management in a Network of Moving Things,” filed on Sep. 22, 2015; U.S. Provisional Patent Application Ser. No. 62/222,192, titled “Communication Network of Moving Things,” filed on Sep. 22, 2015; U.S. Provisional Application Ser. No. 62/244,828, titled “Utilizing Historical Data to Correct GPS Data in a Network of Moving Things,” filed on Oct. 22, 2015; U.S. Provisional Application Ser. No. 62/244,930, titled “Using Anchors to Correct GPS Data in a Network of Moving Things,” filed on Oct. 22, 2015; U.S. Provisional Application Ser. No. 62/246,368, titled “Systems and Methods for Inter-Application Communication in a Network of Moving Things,” filed on Oct. 26, 2015; U.S. Provisional Application Ser. No. 62/246,372, titled “Systems and Methods for Probing and Validating Communication in a Network of Moving Things,” filed on Oct. 26, 2015; U.S. Provisional Application Ser. No. 62/250,544, titled “Adaptive Rate Control for Vehicular Networks,” filed on Nov. 4, 2015; U.S. Provisional Application Ser. No. 62/273,878, titled “Systems and Methods for Reconfiguring and Adapting Hardware in a Network of Moving Things,” filed on Dec. 31, 2015; U.S. Provisional Application Ser. No. 62/253,249, titled “Systems and Methods for Optimizing Data Gathering in a Network of Moving Things,” filed on Nov. 10, 2015; U.S. Provisional Application Ser. No. 62/257,421, titled “Systems and Methods for Delay Tolerant Networking in a Network of Moving Things,” filed on Nov. 19, 2015; U.S. Provisional Application Ser. No. 62/265,267, titled “Systems and Methods for Improving Coverage and Throughput of Mobile Access Points in a Network of Moving Things,” filed on Dec. 9, 2015; U.S. Provisional Application Ser. No. 62/270,858, titled “Channel Coordination in a Network of Moving Things,” filed on Dec. 22, 2015; U.S. Provisional Application Ser. No. 62/257,854, titled “Systems and Methods for Network Coded Mesh Networking in a Network of Moving Things,” filed on Nov. 20, 2015; U.S. Provisional Application Ser. No. 62/260,749, titled “Systems and Methods for Improving Fixed Access Point Coverage in a Network of Moving Things,” filed on Nov. 30, 2015; U.S. Provisional Application Ser. No. 62/273,715, titled “Systems and Methods for Managing Mobility Controllers and Their Network Interactions in a Network of Moving Things,” filed on Dec. 31, 2015; U.S. Provisional Application Ser. No. 62/281,432, titled “Systems and Methods for Managing and Triggering Handovers of Mobile Access Points in a Network of Moving Things,” filed on Jan. 21, 2016; U.S. Provisional Application Ser. No. 62/268,188, titled “Captive Portal-related Control and Management in a Network of Moving Things,” filed on Dec. 16, 2015; U.S. Provisional Application Ser. No. 62/270,678, titled “Systems and Methods to Extrapolate High-Value Data from a Network of Moving Things,” filed on Dec. 22, 2015; U.S. Provisional Application Ser. No. 62/272,750, titled “Systems and Methods for Remote Software Update and Distribution in a Network of Moving Things,” filed on Dec. 30, 2015; U.S. Provisional Application Ser. No. 62/278,662, titled “Systems and Methods for Remote Configuration Update and Distribution in a Network of Moving Things,” filed on Jan. 14, 2016; U.S. Provisional Application Ser. No. 62/286,243, titled “Systems and Methods for Adapting a Network of Moving Things Based on User Feedback,” filed on Jan. 22, 2016; U.S. Provisional Application Ser. No. 62/278,764, titled “Systems and Methods to Guarantee Data Integrity When Building Data Analytics in a Network of Moving Things,” Jan. 14, 2016; U.S. Provisional Application Ser. No. 62/286,515, titled “Systems and Methods for Self-Initialization and Automated Bootstrapping of Mobile Access Points in a Network of Moving Things,” filed on Jan. 25, 2016; U.S. Provisional Application Ser. No. 62/295,602, titled “Systems and Methods for Power Management in a Network of Moving Things,” filed on Feb. 16, 2016; and U.S. Provisional Application Ser. No. 62/299,269, titled “Systems and Methods for Automating and Easing the Installation and Setup of the Infrastructure Supporting a Network of Moving Things,” filed on Feb. 24, 2016; each of which is hereby incorporated herein by reference in its entirety for all purposes.

### BACKGROUND

Current communication networks are unable to adequately support communication environments involving moving networks. As a non-limiting example, current communication networks are unable to adequately support a network comprising a complex array of both moving and static nodes, some of which may be network access points (e.g., the Internet of moving things) interacting with sensor systems and/or end user devices. Limitations and disadvantages of conventional methods and systems will become apparent to one of skill in the art, through comparison of such approaches with some aspects of the present methods and systems set forth in the remainder of this disclosure with reference to the drawings.

### BRIEF DESCRIPTION OF SEVERAL VIEWS OF THE DRAWINGS

FIG. 1 shows a block diagram of a communication network, in accordance with various aspects of this disclosure.

FIG. 2 shows a block diagram of a communication network, in accordance with various aspects of this disclosure.

FIG. 3 shows a diagram of a metropolitan area network, in accordance with various aspects of this disclosure.

FIG. 4 shows a block diagram of a communication network, in accordance with various aspects of this disclosure.

FIGS. 5A-5C show a plurality of network configurations illustrating the flexibility and/or and resiliency of a communication network, in accordance with various aspects of this disclosure.

FIG. 6 shows a block diagram of an example network configuration, in accordance with various aspects of the present disclosure.

FIG. 7 shows a block diagram of an example communication network, in accordance with various aspects of the present disclosure.

FIG. 8 shows a flow diagram of an example method of adapting a network of moving things based at least in part on user feedback, in accordance with various aspects of the present disclosure.

FIG. 9 shows a flow diagram of an example method of adapting a network of moving things based at least in part on user feedback, in accordance with various aspects of the present disclosure.

FIG. 10 shows a block diagram of an example scenario, in accordance with various aspects of the present disclosure.

FIG. 11 shows a block diagram of an example scenario, in accordance with various aspects of the present disclosure.

FIG. 12 shows a block diagram of an example scenario, in accordance with various aspects of the present disclosure.

FIG. 13 shows a block diagram of an example scenario, in accordance with various aspects of the present disclosure.

FIG. 14 shows a block diagram of various components of an example network node, in accordance with various aspects of the present disclosure.

### SUMMARY

Various aspects of this disclosure provide systems and methods for adapting a network of moving things, for example including autonomous vehicles, based at least in part on user feedback. As non-limiting examples, various aspects of this disclosure provide systems and methods for obtaining user feedback, communicating user feedback, analyzing obtained user feedback, and determining and implementing corrective action, for example in a real-time or delayed manner.

### DETAILED DESCRIPTION OF VARIOUS ASPECTS OF THE DISCLOSURE

As utilized herein the terms “circuits” and “circuitry” refer to physical electronic components (i.e., hardware) and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (i.e., hardware) and any software and/or firmware (“code”) that may configure the hardware, be executed by the hardware, and or otherwise be associated with the hardware.

As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory setting or trim, etc.).

As utilized herein, “and/or” means any one or more of the items in the list joined by “and/or”. As an example, “x and/or y” means any element of the three-element set {(x), (y), (x, y)}. That is, “x and/or y” means “one or both of x and y.” As another example, “x, y, and/or z” means any element of the seven-element set {(x), (y), (z), (x, y), (x, z), (y, z), (x, y, z)}. That is, “x, y, and/or x” means “one or more of x, y, and z.” As utilized herein, the terms “e.g.,” and “for example,” “exemplary,” and the like set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example an electronic device may be turned sideways so that its “top” surface is facing horizontally and its “side” surface is facing vertically, without departing from the teachings of the present disclosure.

With the proliferation of the mobile and/or static things (e.g., devices, machines, people, etc.) and logistics for such things to become connected to each other (e.g., in the contexts of smart logistics, transportation, environmental sensing, etc.), a platform that is for example always-on, robust, scalable and secure that is capable of providing connectivity, services and Internet access to such things (or objects), anywhere and anytime is desirable. Efficient power utilization within the various components of such system is also desirable.

Accordingly, various aspects of the present disclosure provide a fully-operable, always-on, responsive, robust, scalable, secure platform/system/architecture to provide connectivity, services and Internet access to all mobile things and/or static things (e.g., devices, machines, people, access points, end user devices, sensors, etc.) anywhere and anytime, while operating in an energy-efficient manner.

Various aspects of the present disclosure provide a platform that is flexibly configurable and adaptable to the various requirements, features, and needs of different environments, where each environment may be characterized by a respective level of mobility and density of mobile and/or static things, and the number and/or types of access to those things. Characteristics of various environments may, for example, include high mobility of nodes (e.g., causing contacts or connections to be volatile), high number of neighbors, high number of connected mobile users, mobile access points, availability of multiple networks and technologies (e.g., sometimes within a same area), etc. For example, the mode of operation of the platform may be flexibly adapted from environment to environment, based on each environment's respective requirements and needs, which may be different from other environments. Additionally for example, the platform may be flexibly optimized (e.g., at design/installation time and/or in real-time) for different purposes (e.g., to reduce the latency, increase throughput, reduce power consumption, load balance, increase reliability, make more robust with regard to failures or other disturbances, etc.), for example based on the content, service or data that the platform provides or handles within a particular environment.

In accordance with various aspects of the present disclosure, many control and management services (e.g., mobility, security, routing, etc.) are provided on top of the platform (e.g., directly, using control overlays, using containers, etc.), such services being compatible with the services currently deployed on top of the Internet or other communication network(s).

The communication network (or platform), in whole or in part, may for example be operated in public and/or private modes of operation, for example depending on the use case. The platform may, for example, operate in a public or private mode of operation, depending on the use-case (e.g., public Internet access, municipal environment sensing, fleet operation, etc.).

Additionally for example, in an implementation in which various network components are mobile, the transportation and/or signal control mechanisms may be adapted to serve the needs of the particular implementation. Also for example, wireless transmission power and/or rate may be adapted (e.g., to mitigate interference, to reduce power consumption, to extend the life of network components, etc.

Various example implementations of a platform, in accordance with various aspects of the present disclosure, are capable of connecting different subsystems, even when various other subsystems that may normally be utilized are unavailable. For example, the platform may comprise various built-in redundancies and fail-recovery mechanisms. For example, the platform may comprise a self-healing capability, self-configuration capability, self-adaptation capability, etc. The protocols and functions of the platform may, for example, be prepared to be autonomously and smoothly configured and adapted to the requirements and features of different environments characterized by different levels of mobility and density of things (or objects), the number/types of access to those things. For example, various aspects of the platform may gather context parameters that can influence any or all decisions. Such parameters may, for example, be derived locally, gathered from a neighborhood, Fixed APs, the Cloud, etc. Various aspects of the platform may also, for example, ask for historical information to feed any of the decisions, where such information can be derived from historical data, from surveys, from simulators, etc. Various aspects of the platform may additionally, for example, probe or monitor decisions made throughout the network, for example to evaluate the network and/or the decisions themselves in real-time. Various aspects of the platform may further, for example, enforce the decisions in the network (e.g., after evaluating the probing results). Various aspects of the platform may, for example, establish thresholds to avoid any decision that is to be constantly or repeatedly performed without any significant advantage (e.g., technology change, certificate change, IP change, etc.). Various aspects of the platform may also, for example, learn locally (e.g., with the decisions performed) and dynamically update the decisions.

In addition to (or instead of) failure robustness, a platform may utilize multiple connections (or pathways) that exist between distinct sub-systems or elements within the same sub-system, to increase the robustness and/or load-balancing of the system.

The following discussion will present examples of the functionality performed by various example subsystems of the communication network. It should be understood that the example functionality discussed herein need not be performed by the particular example subsystem or by a single subsystem. For example, the subsystems present herein may interact with each other, and data or control services may be deployed either in a centralized way, or having their functionalities distributed among the different subsystems, for example leveraging the cooperation between the elements of each subsystem.

Various aspects of the present disclosure provide a communication network (e.g., a city-wide vehicular network, a shipping port-sized vehicular network, a campus-wide vehicular network, etc.) that utilizes vehicles (e.g., automobiles, buses, trucks, boats, forklifts, human-operated vehicles, autonomous and/or remote controlled vehicles, etc.) as Wi-Fi hotspots. Note that Wi-Fi is generally used throughout this discussion as an example, but the scope of various aspects of this disclosure is not limited thereto. For example, other wireless LAN technologies, PAN technologies, MAN technologies, etc., may be utilized. Such utilization may, for example, provide cost-effective ways to gather substantial amounts of urban data, and provide for the efficient offloading of traffic from congested cellular networks (or other networks). In controlled areas (e.g., ports, harbors, etc.) with many vehicles, a communication network in accordance with various aspects of this disclosure may expand the wireless coverage of existing enterprise Wi-Fi networks, for example providing for real-time communication with vehicle drivers (e.g., human, computer-controlled, etc.) and other mobile employees without the need for SIM cards or cellular (or other network) data plans.

Vehicles may have many advantageous characteristics that make them useful as Wi-Fi (or general wireless) hotspots. For example, vehicles generally have at least one battery, vehicles are generally densely spread over the city at street level and/or they are able to establish many contacts with each other in a controlled space, and vehicles can communicate with 10× the range of normal Wi-Fi in the 5.9 GHz frequency band, reserved for intelligent transportation systems in the EU, the U.S., and elsewhere. Note that the scope of this disclosure is not limited to such 5.9 GHz wireless communication. Further, vehicles are able to effectively expand their coverage area into a swath over a period of time, enabling a single vehicle access point to interact with substantially more data sources over the period of time.

In accordance with various aspects of the present disclosure, an affordable multi-network on-board unit (OBU) is presented. Note that the OBU may also be referred to herein as a mobile access point, Mobile AP, MAP, etc. The OBU may, for example, comprise a plurality of networking interfaces (e.g., Wi-Fi, 802.11p, 4G, Bluetooth, UWB, etc.). The OBU may, for example, be readily installed in or on private and/or public vehicles (e.g., individual user vehicles, vehicles of private fleets, vehicles of public fleets, etc.). The OBU may, for example, be installed in transportation fleets, waste management fleets, law enforcement fleets, emergency services, road maintenance fleets, taxi fleets, aircraft fleets, etc. The OBU may, for example, be installed in or on a vehicle or other structure with free mobility or relatively limited mobility. The OBU may also, for example, be carried by a person or service animal, mounted to a bicycle, mounted to a moving machine in general, mounted to a container, etc.

The OBUs may, for example, operate to connect passing vehicles to the wired infrastructure of one or more network providers, telecom operators, etc. In accordance with the architecture, hardware, and software functionality discussed herein, vehicles and fleets can be connected not just to the cellular networks (or other wide area or metropolitan area networks, etc.) and existing Wi-Fi hotspots spread over a city or a controlled space, but also to other vehicles (e.g., utilizing multi-hop communications to a wired infrastructure, single or multi-hop peer-to-peer vehicle communication, etc.). The vehicles and/or fleets may, for example, form an overall mesh of communication links, for example including the OBUs and also fixed Access Points (APs) connected to the wired infrastructure (e.g., a local infrastructure, etc.). Note that OBUs herein may also be referred to as “Mobile APs,” “mobile hotspots,” “MAPs,” etc. Also note that fixed access points may also be referred to herein as Road Side Units (RSUs), Fixed APs, FAPs, etc.

In an example implementation, the OBUs may communicate with the Fixed APs utilizing a relatively long-range protocol (e.g., 802.11p, etc.), and the Fixed APs may, in turn, be hard wired to the wired infrastructure (e.g., via cable, tethered optical link, etc.). Note that Fixed APs may also, or alternatively, be coupled to the infrastructure via wireless link (e.g., 802.11p, etc.). Additionally, clients or user devices may communicate with the OBUs using one or more relatively short-range protocols (e.g., Wi-Fi, Bluetooth, UWB, etc.). The OBUs, for example having a longer effective wireless communication range than typical Wi-Fi access points or other wireless LAN/PAN access points (e.g., at least for links such as those based on 802.11p, etc.), are capable of substantially greater coverage areas than typical Wi-Fi or other wireless LAN/PAN access points, and thus fewer OBUs are necessary to provide blanket coverage over a geographical area.

The OBU may, for example, comprise a robust vehicular networking module (e.g., a connection manager) which builds on long-range communication protocol capability (e.g., 802.11p, etc.). For example, in addition to comprising 802.11p (or other long-range protocol) capability to communicate with Fixed APs, vehicles, and other nodes in the network, the OBU may comprise a network interface (e.g., 802.11a/b/g/n, 802.11ac, 802.11af, any combination thereof, etc.) to provide wireless local area network (WLAN) connectivity to end user devices, sensors, fixed Wi-Fi access points, etc. For example, the OBU may operate to provide in-vehicle Wi-Fi Internet access to users in and/or around the vehicle (e.g., a bus, train car, taxi cab, public works vehicle, etc.). The OBU may further comprise one or more wireless backbone communication interfaces (e.g., cellular network interfaces, etc.). Though in various example scenarios, a cellular network interface (or other wireless backbone communication interface) might not be the preferred interface for various reasons (e.g., cost, power, bandwidth, etc.), the cellular network interface may be utilized to provide connectivity in geographical areas that are not presently supported by a Fixed AP, may be utilized to provide a fail-over communication link, may be utilized for emergency communications, may be utilized to subscribe to local infrastructure access, etc. The cellular network interface may also, for example, be utilized to allow the deployment of solutions that are dependent on the cellular network operators.

An OBU, in accordance with various aspects of the present disclosure, may for example comprise a smart connection manager that can select the best available wireless link(s) (e.g., Wi-Fi, 802.11p, cellular, vehicle mesh, etc.) with which to access the Internet. The OBU may also, for example, provide geo-location capabilities (e.g., GPS, etc.), motion detection sensors to determine if the vehicle is in motion, and a power control subsystem (e.g., to ensure that the OBU does not deplete the vehicle battery, etc.). The OBU may, for example, comprise any or all of the sensors (e.g., environmental sensors, etc.) discussed herein.

The OBU may also, for example, comprise a manager that manages machine-to-machine data acquisition and transfer (e.g., in a real-time or delay-tolerant fashion) to and from the cloud. For example, the OBU may log and/or communicate information of the vehicles.

The OBU may, for example, comprise a connection and/or routing manager that operates to perform routing of communications in a vehicle-to-vehicle/vehicle-to-infrastructure multi-hop communication. A mobility manager (or controller, MC) may, for example, ensure that communication sessions persist over one or more handoff(s) (also referred to herein as a “handover” or “handovers”) (e.g., between different Mobile APs, Fixed APs, base stations, hot spots, etc.), among different technologies (e.g., 802.11p, cellular, Wi-Fi, satellite, etc.), among different MCs (e.g., in a fail-over scenario, load redistribution scenario, etc.), across different interfaces (or ports), etc. Note that the MC may also be referred to herein as a Local Mobility Anchor (LMA), a Network Controller, etc. Note that the MC, or a plurality thereof, may for example be implemented as part of the backbone, but may also, or alternatively, be implemented as part of any of a variety of components or combinations thereof. For example, the MC may be implemented in a Fixed AP (or distributed system thereof), as part of an OBU (or a distributed system thereof), etc. Various non-limiting examples of system components and/or methods are provided in U.S. Provisional Application No. 62/222,098, filed Sep. 22, 2015, and titled “Systems and Method for Managing Mobility in a Network of Moving Things,” the entire contents of which are hereby incorporated herein by reference. Note that in an example implementation including a plurality of MCs, such MCs may be co-located and/or may be geographically distributed.

Various aspects of the present disclosure also provide a cloud-based service-oriented architecture that handles the real-time management, monitoring and reporting of the network and clients, the functionalities required for data storage, processing and management, the Wi-Fi client authentication and Captive Portal display, etc.

A communication network (or component thereof) in accordance with various aspects of the present disclosure may, for example, support a wide range of smart city applications (or controlled scenarios, or connected scenarios, etc.) and/or use-cases, as described herein.

For example, an example implementation may operate to turn each vehicle (e.g., both public and private taxis, buses, trucks, etc.) into a Mobile AP (e.g., a mobile Wi-Fi hotspot), offering Internet access to employees, passengers and mobile users travelling in the city, waiting in bus stops, sitting in parks, etc. Moreover, through an example vehicular mesh network formed between vehicles and/or fleets of vehicles, an implementation may be operable to offload cellular traffic through the mobile Wi-Fi hotspots and/or Fixed APs (e.g., 802.11p-based APs) spread over the city and connected to the wired infrastructure of public or private telecom operators in strategic places, while ensuring the widest possible coverage at the lowest possible cost.

An example implementation (e.g., of a communication network and/or components thereof) may, for example, be operable as a massive urban scanner that gathers large amounts of data (e.g., continuously) on-the-move, actionable or not, generated by a myriad of sources spanning from the in-vehicle sensors or On Board Diagnostic System port (e.g., OBD2, etc.), interface with an autonomous vehicle driving system, external Wi-Fi/Bluetooth-enabled sensing units spread over the city, devices of vehicles' drivers and passengers (e.g., information characterizing such devices and/or passengers, etc.), positioning system devices (e.g., position information, velocity information, trajectory information, travel history information, etc.), etc.

Depending on the use case, the OBU may for example process (or computer, transform, manipulate, aggregate, summarize, etc.) the data before sending the data from the vehicle, for example providing the appropriate granularity (e.g., value resolution) and sampling rates (e.g., temporal resolution) for each individual application. For example, the OBU may, for example, process the data in any manner deemed advantageous by the system. The OBU may, for example, send the collected data (e.g., raw data, preprocessed data, information of metrics calculated based on the collected data, etc.) to the Cloud (e.g., to one or more networked servers coupled to any portion of the network) in an efficient and reliable manner to improve the efficiency, environmental impact and social value of municipal city operations and transportation services. Various example use cases are described herein.

In an example scenario in which public buses are moving along city routes and/or taxis are performing their private transportation services, the OBU is able to collect large quantities of real-time data from the positioning systems (e.g., GPS, etc.), from accelerometer modules, etc. The OBU may then, for example, communicate such data to the Cloud, where the data may be processed, reported and viewed, for example to support such public or private bus and/or taxi operations, for example supporting efficient remote monitoring and scheduling of buses and taxis, respectively.

In an example implementation, small cameras (or other sensors) may be coupled to small single-board computers (SBCs) that are placed above the doors of public buses to allow capturing image sequences of people entering and leaving buses, and/or on stops along the bus routes in order to estimate the number of people waiting for a bus. Such data may be gathered by the OBU in order to be sent to the Cloud. With such data, public transportation systems may detect peaks; overcrowded buses, routes and stops; underutilized buses, routes and stops; etc., enabling action to be taken in real-time (e.g., reducing bus periodicity to decrease fuel costs and CO₂ emissions where and when passenger flows are smaller, etc.) as well as detecting systematic transportation problems.

An OBU may, for example, be operable to communicate with any of a variety of Wi-Fi-enabled sensor devices equipped with a heterogeneous collection of environmental sensors. Such sensors may, for example, comprise noise sensors (microphones, etc.), gas sensors (e.g., sensing CO, NO₂, O₃, volatile organic compounds (or VOCs), CO₂, etc.), smoke sensors, pollution sensors, meteorological sensors (e.g., sensing temperature, humidity, luminosity, particles, solar radiation, wind speed (e.g., anemometer), wind direction, rain (e.g., a pluviometer), optical scanners, biometric scanners, cameras, microphones, etc.). Such sensors may also comprise sensors associated with users (e.g., vehicle operators or passengers, passersby, etc.) and/or their personal devices (e.g., smart phones or watches, biometrics sensors, wearable sensors, implanted sensors, etc.). Such sensors may, for example, comprise sensors and/or systems associated with on-board diagnostic (OBD) units for vehicles, autonomous vehicle driving systems, etc. Such sensors may, for example, comprise positioning sensors (e.g., GPS sensors, Galileo sensors, GLONASS sensors, etc.). Note that such positioning sensors may be part of a vehicle's operational system (e.g., a local human-controlled vehicle, an autonomous vehicle, a remote human-controlled vehicle, etc.) Such sensors may, for example, comprise container sensors (e.g., garbage can sensors, shipping container sensors, container environmental sensors, container tracking sensors, etc.).

Once a vehicle enters the vicinity of such a sensor device, a wireless link may be established, so that the vehicle (or OBU thereof) can collect sensor data from the sensor device and upload the collected data to a database in the Cloud. The appropriate action can then be taken. In an example waste management implementation, several waste management (or collection) trucks may be equipped with OBUs that are able to periodically communicate with sensors installed on containers in order to gather information about waste level, time passed since last collection, etc. Such information may then sent to the Cloud (e.g., to a waste management application coupled to the Internet, etc.) through the vehicular mesh network, in order to improve the scheduling and/or routing of waste management trucks. Note that various sensors may always be in range of the Mobile AP (e.g., vehicle-mounted sensors). Note that the sensor may also (or alternatively) be mobile (e.g., a sensor mounted to another vehicle passing by a Mobile AP or Fixed AP, a drone-mounted sensor, a pedestrian-mounted sensor, etc.).

In an example implementation, for example in a controlled space (e.g., a port, harbor, airport, factory, plantation, mine, etc.) with many vehicles, machines and employees, a communication network in accordance with various aspects of the present disclosure may expand the wireless coverage of enterprise and/or local Wi-Fi networks, for example without resorting to a Telco-dependent solution based on SIM cards or cellular fees. In such an example scenario, apart from avoiding expensive cellular data plans, limited data rate and poor cellular coverage in some places, a communication network in accordance with various aspects of the present disclosure is also able to collect and/or communicate large amounts of data, in a reliable and real-time manner, where such data may be used to optimize harbor logistics, transportation operations, etc.

For example in a port and/or harbor implementation, by gathering real-time information on the position, speed, fuel consumption and CO₂ emissions of the vehicles, the communication network allows a port operator to improve the coordination of the ship loading processes and increase the throughput of the harbor. Also for example, the communication network enables remote monitoring of drivers' behaviors, behaviors of autonomous vehicles and/or control systems thereof, trucks' positions and engines' status, and then be able to provide real-time notifications to drivers (e.g., to turn on/off the engine, follow the right route inside the harbor, take a break, etc.), for example human drivers and/or automated vehicle driving systems, thus reducing the number and duration of the harbor services and trips. Harbor authorities may, for example, quickly detect malfunctioning trucks and abnormal trucks' circulation, thus avoiding accidents in order to increase harbor efficiency, security, and safety. Additionally, the vehicles can also connect to Wi-Fi access points from harbor local operators, and provide Wi-Fi Internet access to vehicles' occupants and surrounding harbor employees, for example allowing pilots to save time by filing reports via the Internet while still on the water.

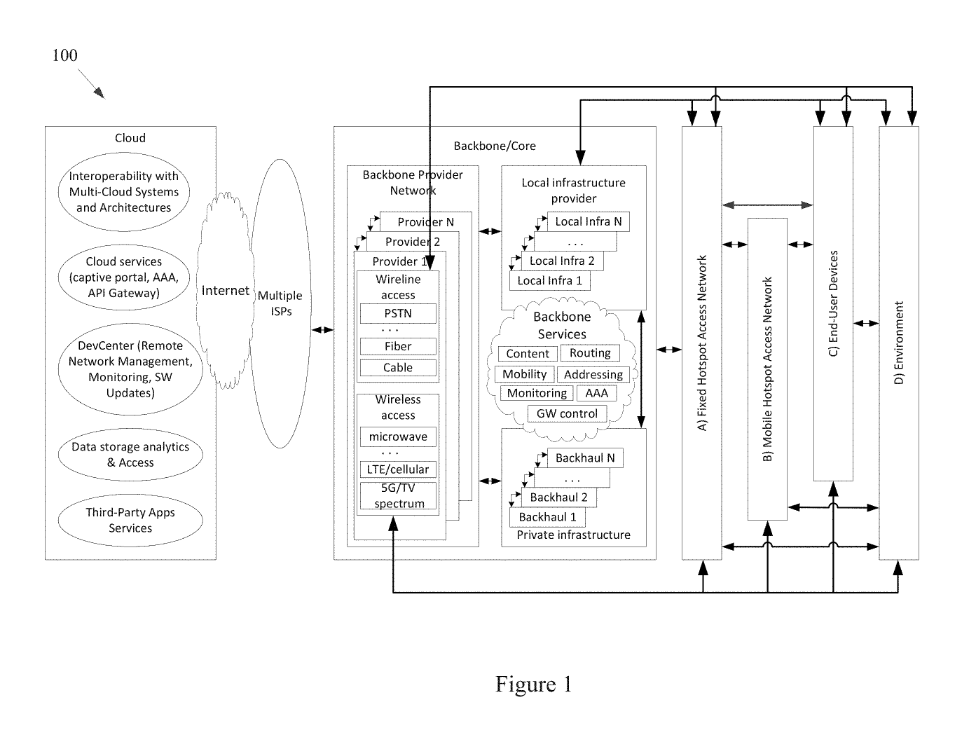

FIG. 1 shows a block diagram of a communication network 100, in accordance with various aspects of this disclosure. Any or all of the functionality discussed herein may be performed by any or all of the example components of the example network 100. Also, the example network 100 may, for example, share any or all characteristics with the other example methods, networks, and/or network components 200, 300, 400, 500-570, 600, 700, 800, 900, 1000, 1100, 1200, 1300, and 1400, discussed herein.

The example network 100, for example, comprises a Cloud that may, for example comprise any of a variety of network level components. The Cloud may, for example, comprise any of a variety of server systems executing applications that monitor and/or control components of the network 100. Such applications may also, for example, manage the collection of information from any of a large array of networked information sources, many examples of which are discussed herein. The Cloud (or a portion thereof) may also be referred to, at times, as an API. For example, Cloud (or a portion thereof) may provide one or more application programming interfaces (APIs) which other devices may use for communicating/interacting with the Cloud.

An example component of the Cloud may, for example, manage interoperability with various multi-cloud systems and architectures. Another example component (e.g., a Cloud service component) may, for example, provide various cloud services (e.g., captive portal services, authentication, authorization, and accounting (AAA) services, API Gateway services, etc.). An additional example component (e.g., a DevCenter component) may, for example, provide network monitoring and/or management functionality, manage the implementation of software updates, etc. A further example component of the Cloud may manage data storage, data analytics, data access, etc. A still further example component of the Cloud may include any of a variety of third-partly applications and services.

The Cloud may, for example, be coupled to the Backbone/Core Infrastructure of the example network 100 via the Internet (e.g., utilizing one or more Internet Service Providers). Though the Internet is provided by example, it should be understood that scope of the present disclosure is not limited thereto.

The Backbone/Core may, for example, comprise any one or more different communication infrastructure components. For example, one or more providers may provide backbone networks or various components thereof. As shown in the example network 100 illustrated in FIG. 1, a Backbone provider may provide wireline access (e.g., PSTN, fiber, cable, etc.). Also for example, a Backbone provider may provide wireless access (e.g., Microwave, LTE/Cellular, 5G/TV Spectrum, etc.).

The Backbone/Core may also, for example, comprise one or more Local Infrastructure Providers. The Backbone/Core may also, for example, comprise a private infrastructure (e.g., run by the network 100 implementer, owner, etc.). The Backbone/Core may, for example, provide any of a variety of Backbone Services (e.g., AAA, Mobility, Monitoring, Addressing, Routing, Content services, Gateway Control services, etc.).

The Backbone/Core Infrastructure may comprise any of a variety of characteristics, non-limiting examples of which are provided herein. For example, the Backbone/Core may be compatible with different wireless or wired technologies for backbone access. The Backbone/Core may also be adaptable to handle public (e.g., municipal, city, campus, etc.) and/or private (e.g., ports, campus, etc.) network infrastructures owned by different local providers, and/or owned by the network implementer or stakeholder. The Backbone/Core may, for example, comprise and/or interface with different Authentication, Authorization, and Accounting (AAA) mechanisms.

The Backbone/Core Infrastructure may, for example, support different modes of operation (e.g., L2 in port implementations, L3 in on-land public transportation implementations, utilizing any one or more of a plurality of different layers of digital IP networking, any combinations thereof, equivalents thereof, etc.) or addressing pools. The Backbone/Core may also for example, be agnostic to the Cloud provider(s) and/or Internet Service Provider(s). Additionally for example, the Backbone/Core may be agnostic to requests coming from any or all subsystems of the network 100 (e.g., Mobile APs or OBUs (On Board Units), Fixed APs or RSUs (Road Side Units), MCs (Mobility Controllers) or LMAs (Local Mobility Anchors) or Network Controllers, etc.) and/or third-party systems.

The Backbone/Core Infrastructure may, for example, comprise the ability to utilize and/or interface with different data storage/processing systems (e.g., MongoDB, MySql, Redis, etc.). The Backbone/Core Infrastructure may further, for example, provide different levels of simultaneous access to the infrastructure, services, data, etc.

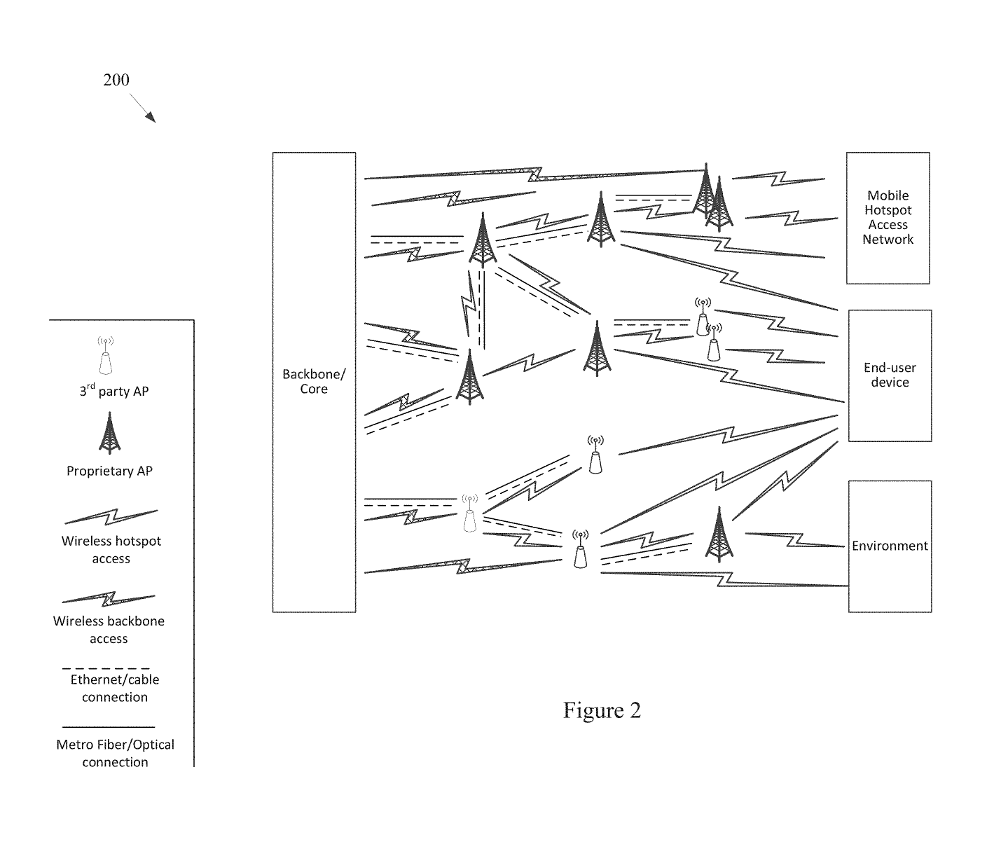

The example network 100 may also, for example, comprise a Fixed Hotspot Access Network. Various example characteristics of such a Fixed Hotspot Access Network 200 are shown at FIG. 2. The example network 200 may, for example, share any or all characteristics with the other example methods, networks, and/or network components 100, 300, 400, 500-570, 600, 700, 800, 900, 1000, 1100, 1200, 1300, and 1400, discussed herein.

In the example network 200, the Fixed APs (e.g., the proprietary APs, the public third party APs, the private third party APs, etc.) may be directly connected to the local infrastructure provider and/or to the wireline/wireless backbone. Also for example, the example network 200 may comprise a mesh between the various APs via wireless technologies. Note, however, that various wired technologies may also be utilized depending on the implementation. As shown, different fixed hotspot access networks can be connected to a same backbone provider, but may also be connected to different respective backbone providers. In an example implementation utilizing wireless technology for backbone access, such an implementation may be relatively fault tolerant. For example, a Fixed AP may utilize wireless communications to the backbone network (e.g., cellular, 3G, LTE, other wide or metropolitan area networks, etc.) if the backhaul infrastructure is down. Also for example, such an implementation may provide for relatively easy installation (e.g., a Fixed AP with no cable power source that can be placed virtually anywhere).

In the example network 200, the same Fixed AP can simultaneously provide access to multiple Fixed APs, Mobile APs (e.g., vehicle OBUs, etc.), devices, user devices, sensors, things, etc. For example, a plurality of mobile hotspot access networks (e.g., OBU-based networks, etc.) may utilize the same Fixed AP. Also for example, the same Fixed AP can provide a plurality of simultaneous accesses to another single unit (e.g., another Fixed AP, Mobile AP, device, etc.), for example utilizing different channels, different radios, etc.).

Note that a plurality of Fixed APs may be utilized for fault-tolerance/fail-recovery purposes. In an example implementation, a Fixed AP and its fail-over AP may both be normally operational (e.g., in a same switch). Also for example, one or more Fixed APs may be placed in the network at various locations in an inactive or monitoring mode, and ready to become operational when needed (e.g., in response to a fault, in response to an emergency services need, in response to a data surge, etc.).

Referring back to FIG. 1, the example Fixed Hotspot Access Network is shown with a wireless communication link to a backbone provider (e.g., to one or more Backbone Providers and/or Local Infrastructure Providers), to a Mobile Hotspot Access Network, to one or more End User Devices, and to the Environment. Also, the example Fixed Hotspot Access Network is shown with a wired communication link to one or more Backbone Providers, to the Mobile Hotspot Access Network, to one or more End User Devices, and to the Environment. The Environment may comprise any of a variety of devices (e.g., in-vehicle networks, devices, and sensors; autonomous vehicle networks, devices, and sensors; maritime (or watercraft) and port networks, devices, and sensors; general controlled-space networks, devices, and sensors; residential networks, devices, and sensors; disaster recovery & emergency networks, devices, and sensors; military and aircraft networks, devices, and sensors; smart city networks, devices, and sensors; event (or venue) networks, devices, and sensors; underwater and underground networks, devices, and sensors; agricultural networks, devices, and sensors; tunnel (auto, subway, train, etc.) networks, devices, and sensors; parking networks, devices, and sensors; security and surveillance networks, devices, and sensors; shipping equipment and container networks, devices, and sensors; environmental control or monitoring networks, devices, and sensors; municipal networks, devices, and sensors; waste management networks, devices, and sensors, road maintenance networks, devices, and sensors, traffic management networks, devices, and sensors; advertising networks, devices and sensors; etc.).

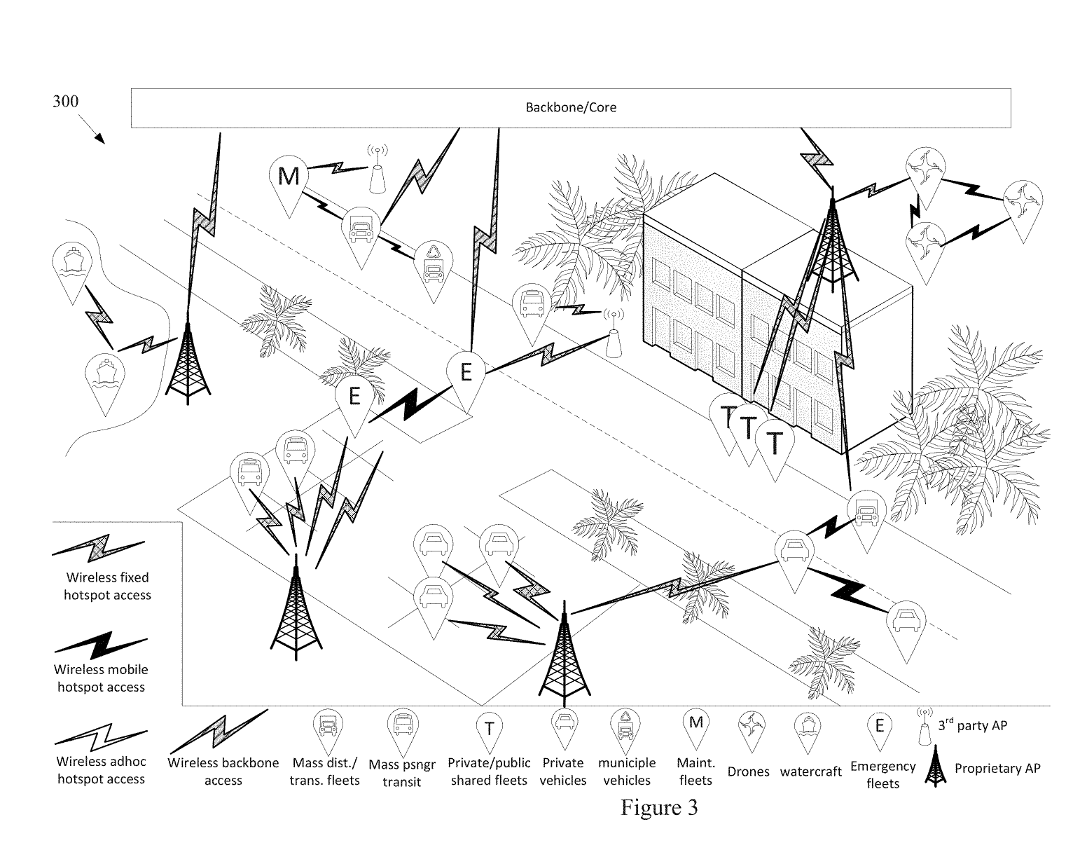

The example network 100 of FIG. 1 also comprises a Mobile Hotspot Access Network. Various example characteristics of such a Mobile Hotspot Access Network 300 are shown at FIG. 3. Note that various fixed network components (e.g., Fixed APs) are also illustrated. The example network 300 may, for example, share any or all characteristics with the other example methods, networks, and/or network components 100, 200, 400, 500-570, 600, 700, 800, 900, 1000, 1100, 1200, 1300, and 1400, discussed herein.

The example network 300 comprises a wide variety of Mobile APs (or hotspots) that provide access to user devices, provide for sensor data collection, provide multi-hop connectivity to other Mobile APs, etc. For example, the example network 300 comprises vehicles from different fleets (e.g., aerial, terrestrial, underground, (under)water, etc.). For example, the example network 300 comprises one or more mass distribution/transportation fleets, one or more mass passenger transportation fleets, private/public shared-user fleets, private vehicles, urban and municipal fleets, maintenance fleets, drones, watercraft (e.g., boats, ships, speedboats, tugboats, barges, etc.), emergency fleets (e.g., police, ambulance, firefighter, etc.), etc.

The example network 300, for example, shows vehicles from different fleets directly connected and/or mesh connected, for example using same or different communication technologies. The example network 300 also shows fleets simultaneously connected to different Fixed APs, which may or may not belong to different respective local infrastructure providers. As a fault-tolerance mechanism, the example network 300 may for example comprise the utilization of long-range wireless communication network (e.g., cellular, 3G, 4G, LTE, etc.) in vehicles if the local network infrastructure is down or otherwise unavailable. A same vehicle (e.g., Mobile AP or OBU) can simultaneously provide access to multiple vehicles, devices, things, etc., for example using a same communication technology (e.g., shared channels and/or different respective channels thereof) and/or using a different respective communication technology for each. Also for example, a same vehicle can provide multiple accesses to another vehicle, device, thing, etc., for example using a same communication technology (e.g., shared channels and/or different respective channels thereof, and/or using a different communication technology).

Additionally, multiple network elements may be connected together to provide for fault-tolerance or fail recovery, increased throughput, or to achieve any or a variety of a client's networking needs, many of examples of which are provided herein. For example, two Mobile APs (or OBUs) may be installed in a same vehicle, etc.

Referring back to FIG. 1, the example Mobile Hotspot Access Network is shown with a wireless communication link to a backbone provider (e.g., to one or more Backbone Providers and/or Local Infrastructure Providers), to a Fixed Hotspot Access Network, to one or more End User Device, and to the Environment (e.g., to any one of more of the sensors or systems discussed herein, any other device or machine, etc.). Though the Mobile Hotspot Access Network is not shown having a wired link to the various other components, there may (at least at times) be such a wired link, at least temporarily.

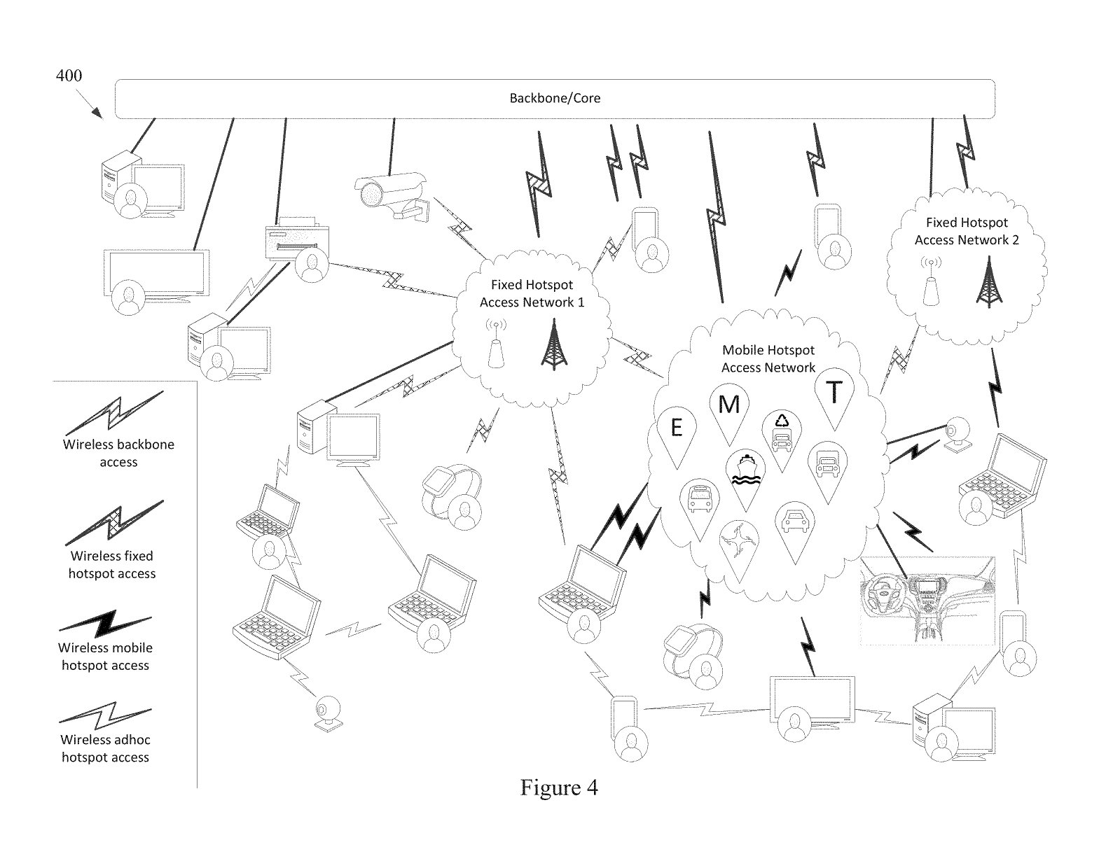

The example network 100 of FIG. 1 also comprises a set of End-User Devices. Various example end user devices are shown at FIG. 4. Note that various other network components (e.g., Fixed Hotspot Access Networks, Mobile Hotspot Access Network(s), the Backbone/Core, etc.) are also illustrated. The example network 400 may, for example, share any or all characteristics with the other example methods, networks, and/or network components 100, 200, 300, 500-570, 600, 700, 800, 900, 1000, 1100, 1200, 1300, and 1400, discussed herein.

The example network 400 shows various mobile networked devices. Such network devices may comprise end-user devices (e.g., smartphones, tablets, smartwatches, laptop computers, webcams, personal gaming devices, personal navigation devices, personal media devices, personal cameras, health-monitoring devices, personal location devices, monitoring panels, printers, etc.). Such networked devices may also comprise any of a variety of devices operating in the general environment, where such devices might not for example be associated with a particular user (e.g. any or all of the sensor devices discussed herein, vehicle sensors, municipal sensors, fleet sensors road sensors, environmental sensors, security sensors, traffic sensors, waste sensors, meteorological sensors, any of a variety of different types of municipal or enterprise equipment, etc.). Any of such networked devices can be flexibly connected to distinct backbone, fixed hotspot access networks, mobile hotspot access networks, etc., using the same or different wired/wireless technologies.

A mobile device may, for example, operate as an AP to provide simultaneous access to multiple devices/things, which may then form ad hoc networks, interconnecting devices ultimately connected to distinct backbone networks, fixed hotspot, and/or mobile hotspot access networks. Devices (e.g., any or all of the devices or network nodes discussed herein) may, for example, have redundant technologies to access distinct backbone, fixed hotspot, and/or mobile hotspot access networks, for example for fault-tolerance and/or load-balancing purposes (e.g., utilizing multiple SIM cards, etc.). A device may also, for example, simultaneously access distinct backbone, fixed hotspot access networks, and/or mobile hotspot access networks, belonging to the same provider or to different respective providers. Additionally for example, a device can provide multiple accesses to another device/thing (e.g., via different channels, radios, etc.).

Referring back to FIG. 1, the example End-User Devices are shown with a wireless communication link to a backbone provider (e.g., to one or more Backbone Providers and/or Local Infrastructure Providers), to a Fixed Hotspot Access Network, to a Mobile Hotspot Access Network, and to the Environment. Also for example, the example End-User Devices are shown with a wired communication link to a backbone provider, to a Fixed Hotspot Access Network, to a Mobile Hotspot Access Network, and to the Environment.

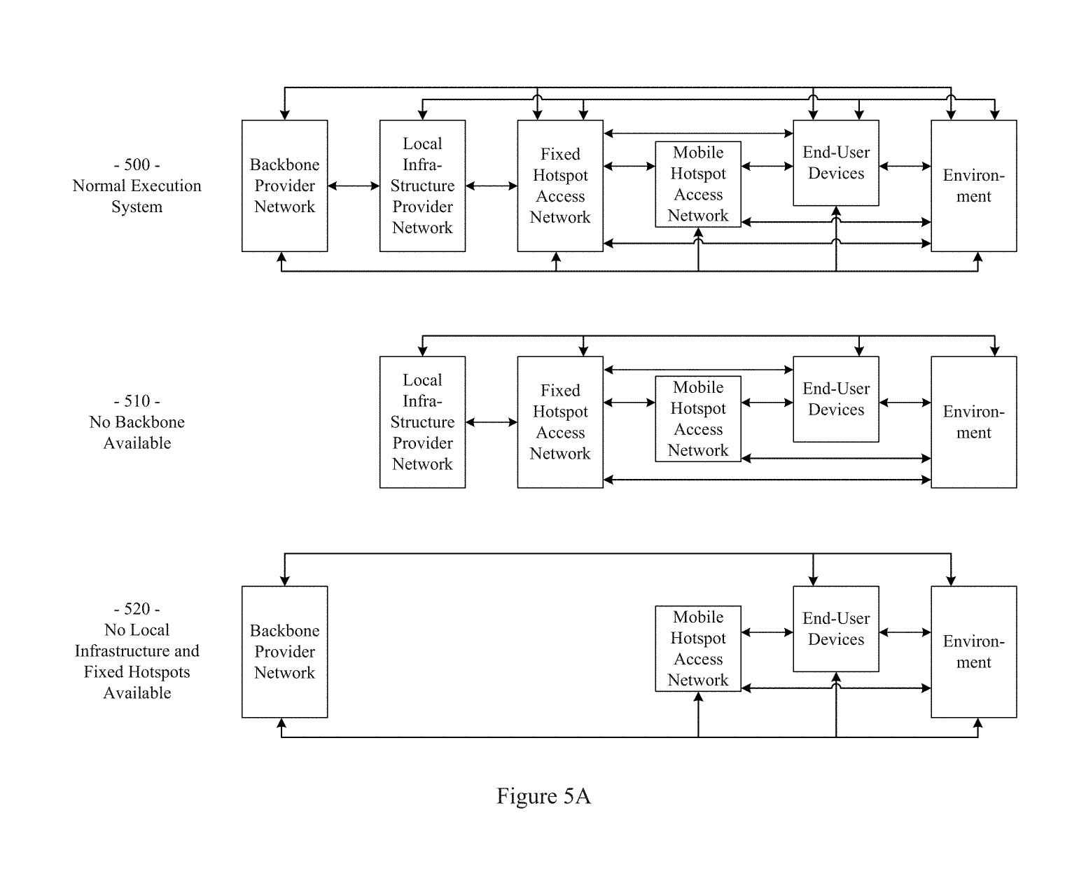

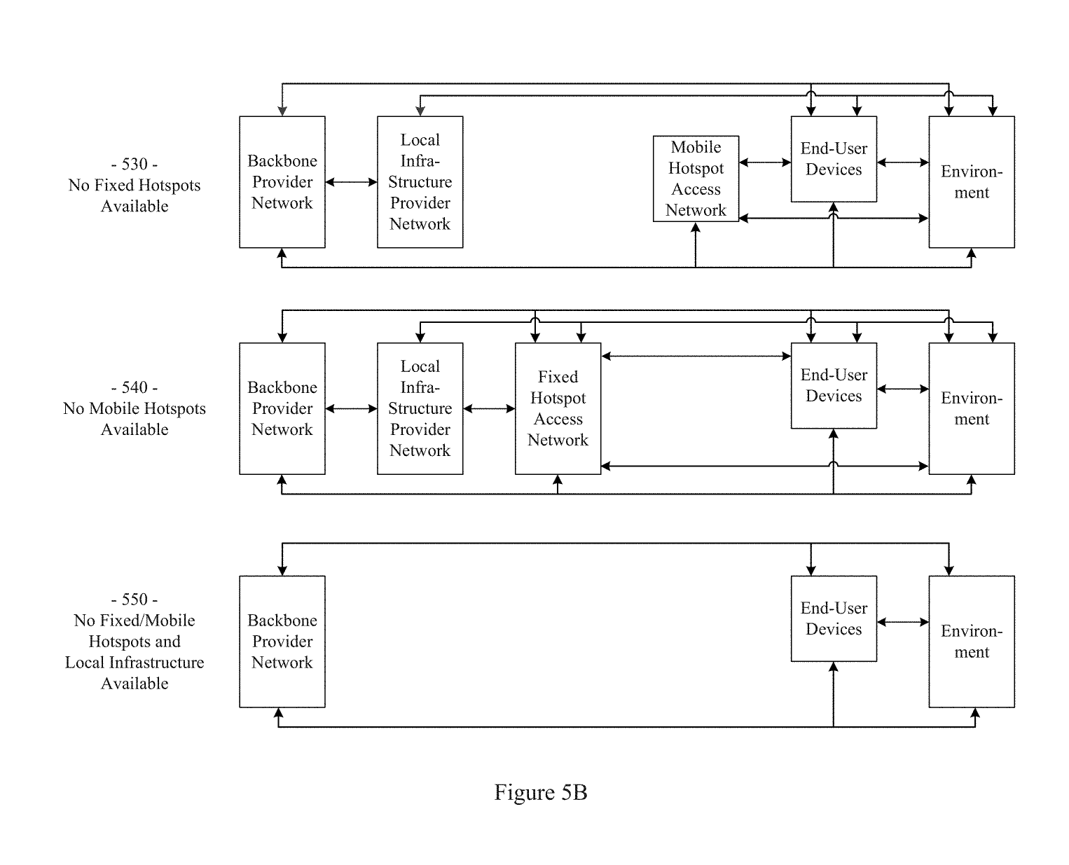

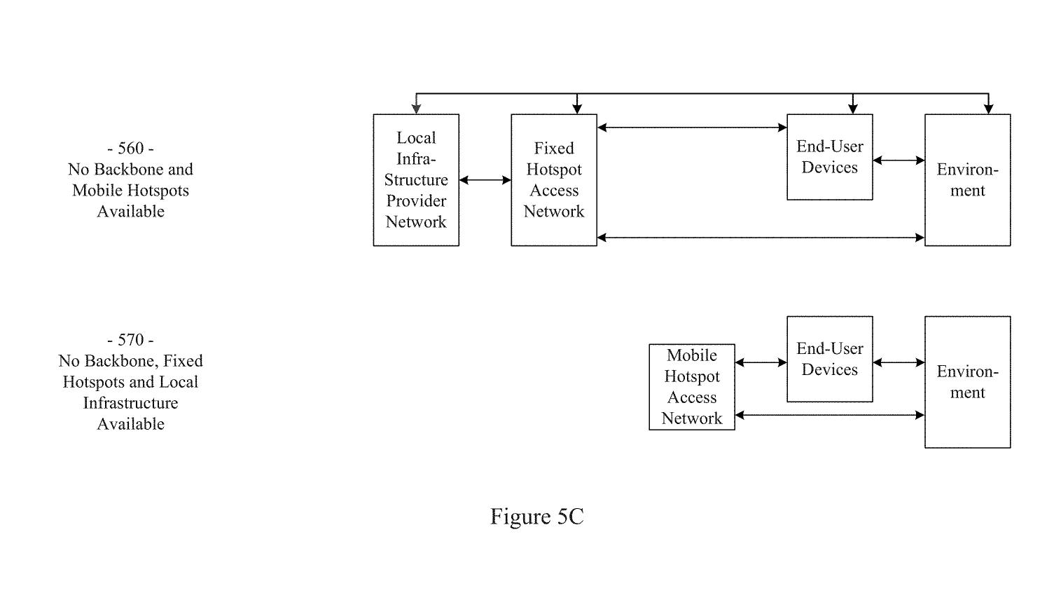

The example network 100 illustrated in FIG. 1 has a flexible architecture that is adaptable at implementation time (e.g., for different use cases) and/or adaptable in real-time, for example as network components enter and leave service. FIGS. 5A-5C illustrate such flexibility by providing example modes (or configurations). The example networks 500-570 may, for example, share any or all characteristics with the other example methods, networks, and/or network components 100, 200, 300, 400, 500-570, 600, 700, 800, 900, 1000, 1100, 1200, 1300, and 1400, discussed herein. For example and without limitation, any or all of the communication links (e.g., wired links, wireless links, etc.) shown in the example networks 500-570 are generally analogous to similarly positioned communication links shown in the example network 100 of FIG. 1.

For example, various aspects of this disclosure provide communication network architectures, systems, and methods for supporting a dynamically configurable communication network comprising a complex array of both static and moving communication nodes (e.g., the Internet of moving things). For example, a communication network implemented in accordance with various aspects of the present disclosure may operate in one of a plurality of modalities comprising various fixed nodes, mobile nodes, and/or a combination thereof, which are selectable to yield any of a variety of system goals (e.g., increased throughput, reduced latency and packet loss, increased availability and robustness of the system, extra redundancy, increased responsiveness, increased security in the transmission of data and/or control packets, reduced number of configuration changes by incorporating smart thresholds (e.g., change of technology, change of certificate, change of IP, etc.), providing connectivity in dead zones or zones with difficult access, reducing the costs for maintenance and accessing the equipment for updating/upgrading, etc.). At least some of such modalities may, for example, be entirely comprised of fixed-position nodes, at least temporarily if not permanently.

For illustrative simplicity, many of the example aspects shown in the example system or network 100 of FIG. 1 (and other Figures herein) are omitted from FIGS. 5A-5C, but may be present. For example, the Cloud, Internet, and ISP aspects shown in FIG. 1 and in other Figures are not explicitly shown in FIGS. 5A-5C, but may be present in any of the example configurations (e.g., as part of the backbone provider network or coupled thereto, as part of the local infrastructure provider network or coupled thereto, etc.).

For example, the first example mode 500 is presented as a normal execution mode, for example a mode (or configuration) in which all of the components discussed herein are present. For example, the communication system in the first example mode 500 comprises a backbone provider network, a local infrastructure provider network, a fixed hotspot access network, a mobile hotspot access network, end-user devices, and environment devices.

As shown in FIG. 5A, and in FIG. 1 in more detail, the backbone provider network may be communicatively coupled to any or all of the other elements present in the first example mode 500 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via a wired link. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the first example mode 500 (or configuration) via one or more wireless links (e.g., RF link, non-tethered optical link, etc.). For example, the backbone provider network may be communicatively coupled to the fixed hotspot access network (or any component thereof), the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

Though not shown in the first example mode 500 (or any of the example modes of FIGS. 5A-5C), one or more servers may be communicatively coupled to the backbone provider network and/or the local infrastructure network. FIG. 1 provides an example of cloud servers being communicatively coupled to the backbone provider network via the Internet.

As additionally shown in FIG. 5A, and in FIG. 1 in more detail, the local infrastructure provider network may be communicatively coupled to any or all of the other elements present in the first example mode 500 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the first example mode 500 (or configuration) via one or more wireless links (e.g., RF link, non-tethered optical link, etc.). For example, the local infrastructure provider network may be communicatively coupled to the backbone provider network (or any component thereof), the fixed hotspot access network (or any component thereof), the mobile hotspot access network (or any component thereof), the end-user devices, and/or environment devices via one or more wireless links. Note that the communication link shown in the first example mode 500 of FIG. 5A between the local infrastructure provider network and the fixed hotspot access network may be wired and/or wireless.

The fixed hotspot access network is also shown in the first example mode 500 to be communicatively coupled to the mobile hotspot access network, the end-user devices, and/or environment devices via one or more wireless links. Many examples of such wireless coupling are provided herein. Additionally, the mobile hotspot access network is further shown in the first example mode 500 to be communicatively coupled to the end-user devices and/or environment devices via one or more wireless links. Many examples of such wireless coupling are provided herein. Further, the end-user devices are also shown in the first example mode 500 to be communicatively coupled to the environment devices via one or more wireless links. Many examples of such wireless coupling are provided herein. Note that in various example implementations any of such wireless links may instead (or in addition) comprise a wired (or tethered) link.

In the first example mode 500 (e.g., the normal mode), information (or data) may be communicated between an end-user device and a server (e.g., a computer system) via the mobile hotspot access network, the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network, the local infrastructure provider network, and/or the backbone provider network (e.g., skipping the mobile hotspot access network). Also for example, information communicated between an end user device and a server may be communicated via the backbone provider network (e.g., skipping the mobile hotspot access network, fixed hotspot access network, and/or local infrastructure provider network).

Similarly, in the first example mode 500 (e.g., the normal mode), information (or data) may be communicated between an environment device and a server via the mobile hotspot access network, the fixed hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network, the local infrastructure provider network, and/or the backbone provider network (e.g., skipping the mobile hotspot access network). Also for example, information communicated between an environment device and a server may be communicated via the backbone provider network (e.g., skipping the mobile hotspot access network, fixed hotspot access network, and/or local infrastructure provider network). Additionally for example, information communicated between an environment device and a server may be communicated via the local infrastructure provider network (e.g., skipping the mobile hotspot access network and/or fixed hotspot access network).

As discussed herein, the example networks presented herein are adaptively configurable to operate in any of a variety of different modes (or configurations). Such adaptive configuration may occur at initial installation and/or during subsequent controlled network evolution (e.g., adding or removing any or all of the network components discussed herein, expanding or removing network capacity, adding or removing coverage areas, adding or removing services, etc.). Such adaptive configuration may also occur in real-time, for example in response to real-time changes in network conditions (e.g., networks or components thereof being available or not based on vehicle or user-device movement, network or component failure, network or component replacement or augmentation activity, network overloading, etc.). The following example modes are presented to illustrate characteristics of various modes in which a communication system may operate in accordance with various aspects of the present disclosure. The following example modes will generally be discussed in relation to the first example mode 500 (e.g., the normal execution mode). Note that such example modes are merely illustrative and not limiting.

The second example mode (or configuration) 510 (e.g., a no backbone available mode) may, for example, share any or all characteristics with the first example mode 500, albeit without the backbone provider network and communication links therewith. For example, the communication system in the second example mode 510 comprises a local infrastructure provider network, a fixed hotspot access network, a mobile hotspot access network, end-user devices, and environment devices.

As shown in FIG. 5A, and in FIG. 1 in more detail, the local infrastructure provider network may be communicatively coupled to any or all of the other elements present in the second example mode 510 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the second example mode 510 (or configuration) via one or more wireless links (e.g., RF link, non-tethered optical link, etc.). For example, the local infrastructure provider network may be communicatively coupled to the fixed hotspot access network (or any component thereof), the mobile hotspot access network (or any component thereof), the end-user devices, and/or environment devices via one or more wireless links. Note that the communication link(s) shown in the second example mode 510 of FIG. 5A between the local infrastructure provider network and the fixed hotspot access network may be wired and/or wireless.

The fixed hotspot access network is also shown in the second example mode 510 to be communicatively coupled to the mobile hotspot access network, the end-user devices, and/or environment devices via one or more wireless links. Many examples of such wireless coupling are provided herein. Additionally, the mobile hotspot access network is further shown in the second example mode 510 to be communicatively coupled to the end-user devices and/or environment devices via one or more wireless links. Many examples of such wireless coupling are provided herein. Further, the end-user devices are also shown in the second example mode 510 to be communicatively coupled to the environment devices via one or more wireless links. Many examples of such wireless coupling are provided herein. Note that in various example implementations any of such wireless links may instead (or in addition) comprise a wired (or tethered) link.

In the second example mode 510 (e.g., the no backbone available mode), information (or data) may be communicated between an end-user device and a server (e.g., a computer, etc.) via the mobile hotspot access network, the fixed hotspot access network, and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network and/or the local infrastructure provider network (e.g., skipping the mobile hotspot access network). Also for example, information communicated between an end user device and a server may be communicated via the local infrastructure provider network (e.g., skipping the mobile hotspot access network and/or fixed hotspot access network).

Similarly, in the second example mode 510 (e.g., the no backbone available mode), information (or data) may be communicated between an environment device and a server via the mobile hotspot access network, the fixed hotspot access network, and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network and/or the local infrastructure provider network (e.g., skipping the mobile hotspot access network). Also for example, information communicated between an environment device and a server may be communicated via the local infrastructure provider network (e.g., skipping the mobile hotspot access network and/or fixed hotspot access network).

The second example mode 510 may be utilized for any of a variety of reasons, non-limiting examples of which are provided herein. For example, due to security and/or privacy goals, the second example mode 510 may be utilized so that communication access to the public Cloud systems, the Internet in general, etc., is not allowed. For example, all network control and management functions may be within the local infrastructure provider network (e.g., wired local network, etc.) and/or the fixed access point network.

In an example implementation, the communication system might be totally owned, operated and/or controlled by a local port authority. No extra expenses associated with cellular connections need be spent. For example, cellular connection capability (e.g., in Mobile APs, Fixed APs, end user devices, environment devices, etc.) need not be provided. Note also that the second example mode 510 may be utilized in a scenario in which the backbone provider network is normally available but is currently unavailable (e.g., due to server failure, due to communication link failure, due to power outage, due to a temporary denial of service, etc.).

The third example mode (or configuration) 520 (e.g., a no local infrastructure and fixed hotspots available mode) may, for example, share any or all characteristics with the first example mode 500, albeit without the local infrastructure provider network, the fixed hotspot access network, and communication links therewith. For example, the communication system in the third example mode 520 comprises a backbone provider network, a mobile hotspot access network, end-user devices, and environment devices.

As shown in FIG. 5A, and in FIG. 1 in more detail, the backbone provider network may be communicatively coupled to any or all of the other elements present in the third example mode 520 (or configuration) via one or more wired (or tethered) links. For example, the backbone provider network may be communicatively coupled to the end-user devices and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the third example mode 520 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links.

The mobile hotspot access network is further shown in the third example mode 520 to be communicatively coupled to the end-user devices and/or environment devices via one or more wireless links. Many examples of such wireless coupling are provided herein. Further, the end-user devices are also shown in the third example mode 520 to be communicatively coupled to the environment devices via one or more wireless links. Many examples of such wireless coupling are provided herein. Note that in various example implementations any of such wireless links may instead (or in addition) comprise a wired (or tethered) link.

In the third example mode 520 (e.g., the no local infrastructure and fixed hotspots available mode), information (or data) may be communicated between an end-user device and a server (e.g., a computer, etc.) via the mobile hotspot access network and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the backbone provider network (e.g., skipping the mobile hotspot access network).

Similarly, in the third example mode 520 (e.g., the no local infrastructure and fixed hotspots available mode), information (or data) may be communicated between an environment device and a server via the mobile hotspot access network and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the backbone provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the backbone provider network (e.g., skipping the mobile hotspot access network).

In the third example mode 520, all control/management functions may for example be implemented within the Cloud. For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The third example mode 520 may be utilized for any of a variety of reasons, non-limiting examples of which are provided herein. In an example implementation, the third example mode 520 may be utilized in an early stage of a larger deployment, for example deployment that will grow into another mode (e.g., the example first mode 500, example fourth mode 530, etc.) as more communication system equipment is installed. Note also that the third example mode 520 may be utilized in a scenario in which the local infrastructure provider network and fixed hotspot access network are normally available but are currently unavailable (e.g., due to equipment failure, due to communication link failure, due to power outage, due to a temporary denial of service, etc.).

The fourth example mode (or configuration) 530 (e.g., a no fixed hotspots available mode) may, for example, share any or all characteristics with the first example mode 500, albeit without the fixed hotspot access network and communication links therewith. For example, the communication system in the fourth example mode 530 comprises a backbone provider network, a local infrastructure provider network, a mobile hotspot access network, end-user devices, and environment devices.

As shown in FIG. 5B, and in FIG. 1 in more detail, the backbone provider network may be communicatively coupled to any or all of the other elements present in the fourth example mode 530 (or configuration) via one or more wired (or tethered) links. For example, the backbone provider network may be communicatively coupled to the local infrastructure provider network (or any component thereof), the end-user devices, and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5B, and in FIG. 1 in more detail, the backbone provider network may be communicatively coupled to any or all of the other elements present in the fourth example mode 530 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fourth example mode 530 (or configuration) via one or more wired (or tethered) links. For example, the local infrastructure provider network may be communicatively coupled to the backbone provider network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fourth example mode 530 (or configuration) via one or more wireless links (e.g., RF link, non-tethered optical link, etc.). For example, the local infrastructure provider network may be communicatively coupled to the backbone provider network (or any component thereof), the mobile hotspot access network (or any component thereof), the end-user devices, and/or environment devices via one or more wireless links.

The mobile hotspot access network is further shown in the fourth example mode 530 to be communicatively coupled to the end-user devices and/or environment devices via one or more wireless links. Many examples of such wireless coupling are provided herein. Further, the end-user devices are also shown in the fourth example mode 530 to be communicatively coupled to the environment devices via one or more wireless links. Many examples of such wireless coupling are provided herein.

In the fourth example mode 530 (e.g., the no fixed hotspots mode), information (or data) may be communicated between an end-user device and a server via the mobile hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network and/or the backbone provider network (e.g., skipping the mobile hotspot access network). Also for example, information communicated between an end user device and a server may be communicated via the backbone provider network (e.g., skipping the mobile hotspot access network and/or local infrastructure provider network).

Similarly, in the fourth example mode 530 (e.g., the no fixed hotspots available mode), information (or data) may be communicated between an environment device and a server via the mobile hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the mobile hotspot access network). Also for example, information communicated between an environment device and a server may be communicated via the backbone provider network (e.g., skipping the mobile hotspot access network and/or local infrastructure provider network). Additionally for example, information communicated between an environment device and a server may be communicated via the local infrastructure provider network (e.g., skipping the mobile hotspot access network and/or backbone provider network).

In the fourth example mode 530, in an example implementation, some of the control/management functions may for example be implemented within the local backbone provider network (e.g., within a client premises). For example, communication to the local infrastructure provider may be performed through the backbone provider network (or Cloud). Note that in a scenario in which there is a direct communication pathway between the local infrastructure provider network and the mobile hotspot access network, such communication pathway may be utilized.

For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The fourth example mode 530 may be utilized for any of a variety of reasons, non-limiting examples of which are provided herein. In an example implementation, the fourth example mode 530 may be utilized in an early stage of a larger deployment, for example a deployment that will grow into another mode (e.g., the example first mode 500, etc.) as more communication system equipment is installed. The fourth example mode 530 may, for example, be utilized in a scenario in which there is no fiber (or other) connection available for Fixed APs (e.g., in a maritime scenario, in a plantation scenario, etc.), or in which a Fixed AP is difficult to access or connect. For example, one or more Mobile APs of the mobile hotspot access network may be used as gateways to reach the Cloud. The fourth example mode 530 may also, for example, be utilized when a vehicle fleet and/or the Mobile APs associated therewith are owned by a first entity and the Fixed APs are owned by another entity, and there is no present agreement for communication between the Mobile APs and the Fixed APs. Note also that the fourth example mode 530 may be utilized in a scenario in which the fixed hotspot access network is normally available but are currently unavailable (e.g., due to equipment failure, due to communication link failure, due to power outage, due to a temporary denial of service, etc.).

The fifth example mode (or configuration) 540 (e.g., a no mobile hotspots available mode) may, for example, share any or all characteristics with the first example mode 500, albeit without the mobile hotspot access network and communication links therewith. For example, the communication system in the fifth example mode 540 comprises a backbone provider network, a local infrastructure provider network, a fixed hotspot access network, end-user devices, and environment devices.

As shown in FIG. 5B, and in FIG. 1 in more detail, the backbone provider network may be communicatively coupled to any or all of the other elements present in the fifth example mode 540 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via one or more wired links. Note that such a wired coupling may be temporary.

Also shown in FIG. 5B, and in FIG. 1 in more detail, the backbone provider network may be communicatively coupled to any or all of the other elements present in the fifth example mode 540 (or configuration) via one or more wireless links (e.g., RF link, non-tethered optical link, etc.). For example, the backbone provider network may be communicatively coupled to the fixed hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fifth example mode 540 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fifth example mode 540 (or configuration) via one or more wireless links (e.g., RF link, non-tethered optical link, etc.). For example, the local infrastructure provider network may be communicatively coupled to the backbone provider network, the fixed hotspot access network (or any component thereof), the end-user devices, and/or environment devices via one or more wireless links. Note that the communication link(s) shown in the fifth example mode 540 of FIG. 5B between the local infrastructure provider network and the fixed hotspot access network may be wired and/or wireless.

The fixed hotspot access network is also shown in the fifth example mode 540 to be communicatively coupled to the end-user devices and/or environment devices via one or more wireless links. Many examples of such wireless coupling are provided herein. Further, the end-user devices are also shown in the fifth example mode 540 to be communicatively coupled to the environment devices via one or more wireless links. Many examples of such wireless coupling are provided herein.

In the fifth example mode 540 (e.g., the no mobile hotspots available mode), information (or data) may be communicated between an end-user device and a server via the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network, and/or the backbone provider network (e.g., skipping the fixed hotspot access network). Also for example, information communicated between an end user device and a server may be communicated via the backbone provider network (e.g., skipping the fixed hotspot access network and/or local infrastructure provider network).

Similarly, in the fifth example mode 540 (e.g., the no mobile hotspots available mode), information (or data) may be communicated between an environment device and a server via the fixed hotspot access network, the local infrastructure provider network, and/or the backbone provider network. Also for example, an environment device may communicate with or through an end-user device (e.g., instead of or in addition to the fixed hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the fixed hotspot access network). Also for example, information communicated between an environment device and a server may be communicated via the backbone provider network (e.g., skipping the fixed hotspot access network and/or local infrastructure provider network). Additionally for example, information communicated between an environment device and a server may be communicated via the local infrastructure provider network (e.g., skipping the fixed hotspot access network and/or the backbone provider network).

In the fifth example mode 540, in an example implementation, the end-user devices and environment devices may communicate directly to Fixed APs (e.g., utilizing Ethernet, Wi-Fi, etc.). Also for example, the end-user devices and/or environment devices may communicate directly with the backbone provider network (e.g., utilizing cellular connections, etc.).

The fifth example mode 540 may be utilized for any of a variety of reasons, non-limiting examples of which are provided herein. In an example implementation in which end-user devices and/or environment devices may communicate directly with Fixed APs, such communication may be utilized instead of Mobile AP communication. For example, the fixed hotspot access network might provide coverage for all desired areas.

Note also that the fifth example mode 540 may be utilized in a scenario in which the fixed hotspot access network is normally available but is currently unavailable (e.g., due to equipment failure, due to communication link failure, due to power outage, due to a temporary denial of service, etc.).

The sixth example mode (or configuration) 550 (e.g., the no fixed/mobile hotspots and local infrastructure available mode) may, for example, share any or all characteristics with the first example mode 500, albeit without the local infrastructure provider network, fixed hotspot access network, mobile hotspot access network, and communication links therewith. For example, the communication system in the sixth example mode 550 comprises a backbone provider network, end-user devices, and environment devices.

As shown in FIG. 5B, and in FIG. 1 in more detail, the backbone provider network may be communicatively coupled to any or all of the other elements present in the sixth example mode 550 (or configuration) via one or more wired (or tethered) links. For example, the backbone provider network may be communicatively coupled to the end-user devices and/or environment devices via one or more wired links. Note that such a wired coupling may be temporary.

Also shown in FIG. 5B, and in FIG. 1 in more detail, the backbone provider network may be communicatively coupled to any or all of the other elements present in the sixth example mode 550 (or configuration) via one or more wireless links (e.g., RF link, non-tethered optical link, etc.). For example, the backbone provider network may be communicatively coupled to the end-user devices and/or environment devices via one or more wireless links.

The end-user devices are also shown in the sixth example mode 550 to be communicatively coupled to the environment devices via one or more wireless links. Many examples of such wireless coupling are provided herein.

In the sixth example mode 550 (e.g., the no fixed/mobile hotspots and local infrastructure available mode), information (or data) may be communicated between an end-user device and a server via the backbone provider network. Similarly, in the sixth example mode 550 (e.g., the no fixed/mobile hotspots and local infrastructure mode), information (or data) may be communicated between an environment device and a server via the backbone provider network. Also for example, an environment device may communicate with or through an end-user device (e.g., instead of or in addition to the mobile hotspot access network).

The sixth example mode 550 may be utilized for any of a variety of reasons, non-limiting examples of which are provided herein. In an example implementation, for example in which an end-user has not yet subscribed to the communication system, the end-user device may subscribe to the system through a Cloud application and by communicating directly with the backbone provider network (e.g., via cellular link, etc.). The sixth example mode 550 may also, for example, be utilized in rural areas in which Mobile AP presence is sparse, Fixed AP installation is difficult or impractical, etc.

Note also that the sixth example mode 550 may be utilized in a scenario in which the infrastructure provider network, fixed hotspot access network, and/or mobile hotspot access network are normally available but are currently unavailable (e.g., due to equipment failure, due to communication link failure, due to power outage, due to a temporary denial of service, etc.).

The seventh example mode (or configuration) 560 (e.g., the no backbone and mobile hotspots available mode) may, for example, share any or all characteristics with the first example mode 500, albeit without the backbone provider network, mobile hotspot access network, and communication links therewith. For example, the communication system in the seventh example mode 560 comprises a local infrastructure provider network, fixed hotspot access network, end-user devices, and environment devices.

As shown in FIG. 5C, and in FIG. 1 in more detail, the local infrastructure provider network may be communicatively coupled to any or all of the other elements present in the seventh example mode 560 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary.

Also, though not explicitly shown, the local infrastructure provider network may be communicatively coupled to any or all of the other elements present in the seventh example mode 560 (or configuration) via one or more wireless links (e.g., RF link, non-tethered optical link, etc.). For example, the local infrastructure provider network may be communicatively coupled to the fixed hotspot access network (or any component thereof), the end-user devices, and/or environment devices via one or more wireless links. Note that the communication link shown in the seventh example mode 560 of FIG. 5C between the local infrastructure provider network and the fixed hotspot access network may be wired and/or wireless.

The fixed hotspot access network is also shown in the seventh example mode 560 to be communicatively coupled to the end-user devices and/or environment devices via one or more wireless links. Many examples of such wireless coupling are provided herein. Additionally, the end-user devices are also shown in the seventh example mode 560 to be communicatively coupled to the environment devices via one or more wireless links. Many examples of such wireless coupling are provided herein.

In the seventh example mode 560 (e.g., the no backbone and mobile hotspots available mode), information (or data) may be communicated between an end-user device and a server via the fixed hotspot access network and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network (e.g., skipping the fixed hotspot access network).

Similarly, in the seventh example mode 560 (e.g., the no backbone and mobile hotspots available mode), information (or data) may be communicated between an environment device and a server via the fixed hotspot access network and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the local infrastructure provider network (e.g., skipping the fixed hotspot access network).

The seventh example mode 560 may be utilized for any of a variety of reasons, non-limiting examples of which are provided herein. In an example controlled space implementation, Cloud access might not be provided (e.g., for security reasons, privacy reasons, etc.), and full (or sufficient) coverage of the coverage area is provided by the fixed hotspot access network, and thus the mobile hotspot access network is not needed. For example, the end-user devices and environment devices may communicate directly (e.g., via Ethernet, Wi-Fi, etc.) with the Fixed APs

Note also that the seventh example mode 560 may be utilized in a scenario in which the backbone provider network and/or fixed hotspot access network are normally available but are currently unavailable (e.g., due to equipment failure, due to communication link failure, due to power outage, due to a temporary denial of service, etc.).

The eighth example mode (or configuration) 570 (e.g., the no backbone, fixed hotspots, and local infrastructure available mode) may, for example, share any or all characteristics with the first example mode 500, albeit without the backbone provider network, local infrastructure provider network, fixed hotspot access network, and communication links therewith. For example, the communication system in the eighth example mode 570 comprises a mobile hotspot access network, end-user devices, and environment devices.

As shown in FIG. 5C, and in FIG. 1 in more detail, the mobile hotspot access network is shown in the eighth example mode 570 to be communicatively coupled to the end-user devices and/or environment devices via one or more wireless links. Many examples of such wireless coupling are provided herein. Further, the end-user devices are also shown in the eighth example mode 570 to be communicatively coupled to the environment devices via one or more wireless links. Many examples of such wireless coupling are provided herein.

In the eighth example mode 570 (e.g., the no backbone, fixed hotspots, and local infrastructure available mode), information (or data) might not (at least currently) be communicated between an end-user device and a server (e.g., a coupled to the backbone provider network, local infrastructure provider network, etc.). Similarly, information (or data) might not (at least currently) be communicated between an environment device and a server (e.g., a coupled to the backbone provider network, local infrastructure provider network, etc.). Note that the environment device may communicate with or through an end-user device (e.g., instead of or in addition to the mobile hotspot access network).

The eighth example mode 570 may be utilized for any of a variety of reasons, non-limiting examples of which are provided herein. In an example implementation, the eighth example mode 570 may be utilized for gathering and/or serving data (e.g., in a delay-tolerant networking scenario), providing peer-to-peer communication through the mobile hotspot access network (e.g., between clients of a single Mobile AP, between clients of respective different Mobile APs, etc.), etc. In another example scenario, the eighth example mode 570 may be utilized in a scenario in which vehicle-to-vehicle communications are prioritized above vehicle-to-infrastructure communications. In yet another example scenario, the eighth example mode 570 may be utilized in a scenario in which all infrastructure access is lost (e.g., in tunnels, parking garages, etc.).

Note also that the eighth example mode 570 may be utilized in a scenario in which the backbone provider network, local infrastructure provider network, and/or fixed hotspot access network are normally available but are currently unavailable (e.g., due to equipment failure, due to communication link failure, due to power outage, due to a temporary denial of service, etc.).

As shown and discussed herein, it is beneficial to have a generic platform that allows multi-mode communications of multiple users or machines within different environments, using multiple devices with multiple technologies, connected to multiple moving/static things with multiple technologies, forming wireless (mesh) hotspot networks over different environments, connected to multiple wired/wireless infrastructure/network backbone providers, ultimately connected to the Internet, Cloud or private network infrastructure.

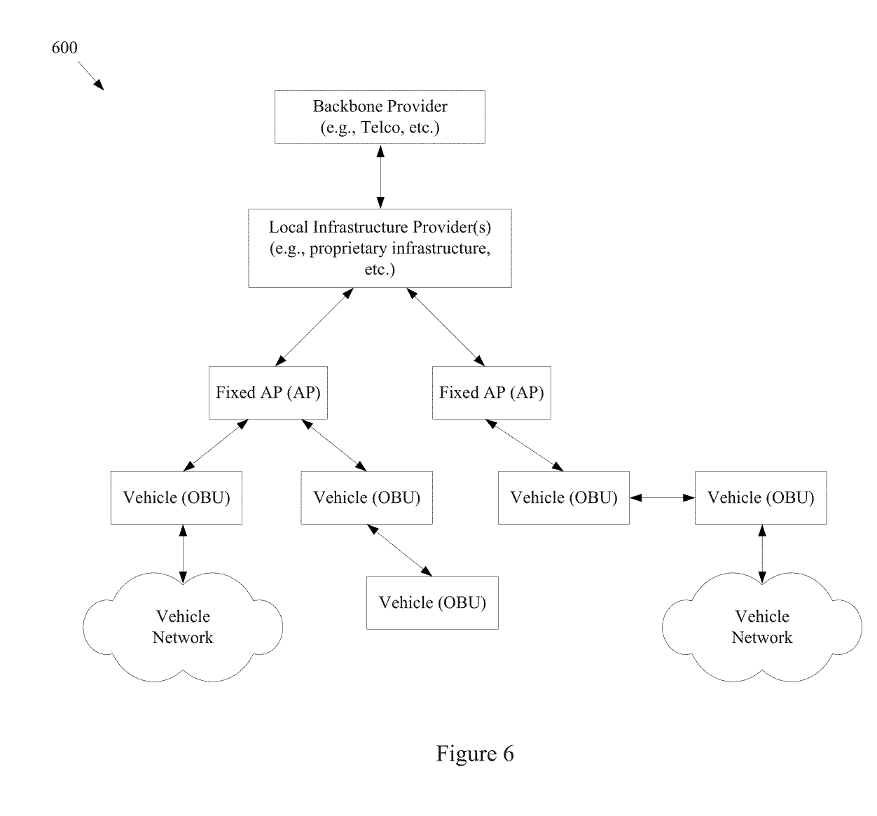

FIG. 6 shows yet another block diagram of an example network configuration, in accordance with various aspects of the present disclosure. The example network 600 may, for example, share any or all characteristics with the other example methods, networks, and/or network components 100, 200, 300, 400, 500-570, 700, 800, 900, 1000, 1100, 1200, 1300, and 1400, discussed herein. Notably, the example network 600 shows a plurality of Mobile APs (or OBUs), each communicatively coupled to a Fixed AP (or RSU), where each Mobile AP may provide network access to a vehicle network (e.g., comprising other vehicles or vehicle networks, user devices, sensor devices, etc.).

In accordance with various aspects of the present disclosure, systems and methods are provided that manage a vehicle communication network, for example in accordance with the location of nodes and end devices, in a way that provides for stable TCP/IP Internet access, among other things. For example, an end user may be provided with a clean and stable Wi-Fi Internet connection that may appear to the end user to be the same as the Wi-Fi Internet connection at the user's home, user's workplace, fixed public Wi-Fi hotspots, etc. For example, for a user utilizing a communication network as described herein, a TCP session may stay active, downloads may process normally, calls may proceed without interruption, etc. As discussed herein, a vehicle communication network in accordance with various aspects of this disclosure may be applied as a transport layer for regular Internet traffic and/or for private network traffic (e.g., extending the access of customer private LANs from the wired network to vehicles and user around them, etc.).

In accordance with an example network implementation, although a user might be always connected to a single Wi-Fi AP of a vehicle, the vehicle (or the access point thereof, for example an OBU) is moving between multiple access points (e.g., Fixed APs, other Mobile APs, cellular base stations, fixed Wi-Fi hotspots, etc.). For example, mobility management implemented in accordance with various aspects of the present disclosure supports the mobility of each vehicle and its users across different communication technologies (e.g., 802.11p, cellular, Wi-Fi, etc.) as the Mobile APs migrate among Fixed APs (and/or Mobile APs) and/or as users migrate between Mobile APs.

In accordance with various aspects of the present disclosure, a mobility controller (MC) may monitor the location (e.g., network location, etc.) of various nodes (e.g., Mobile APs, etc.) and/or the location of end users connected through them. The mobility controller (MC) may, for example, provide seamless handovers (e.g., maintaining communication session continuity) between different access points and/or different technologies with low link latency and low handover times.

The architecture provided herein is scalable, for example taking advantage of redundant elements and/or functionality to provide load-balancing of control and/or data communication functionality, as well as to decrease failure probability. Various aspects of the present disclosure also provide for decreased control signaling (e.g., in amount and/or frequency), which reduces the control overhead and reduces the size of control tables and tunneling, for example both in backend servers and in APs (e.g., Fixed APs and/or Mobile APs).

Additionally, a communication network (or components thereof) in accordance with various aspects of this disclosure may comprise the ability to interact with mobile devices in order to control some or all of their connection choices and/or to leverage their control functionality. For example, in an example implementation, a mobile application can run in the background, managing the available networks and/or nodes thereof and selecting the one that best fits, and then triggering a handoff to the selected network (or node thereof) before breakdown of the current connection.

The communication network (or components thereof) is also configurable, according to the infrastructure requirements and/or mobility needs of each client. For example, the communication network (or components thereof) may comprise the capability to support different Layer 2 (L2) or Layer 3 (L3) implementations, as well as IPv4/IPv6 traffic.

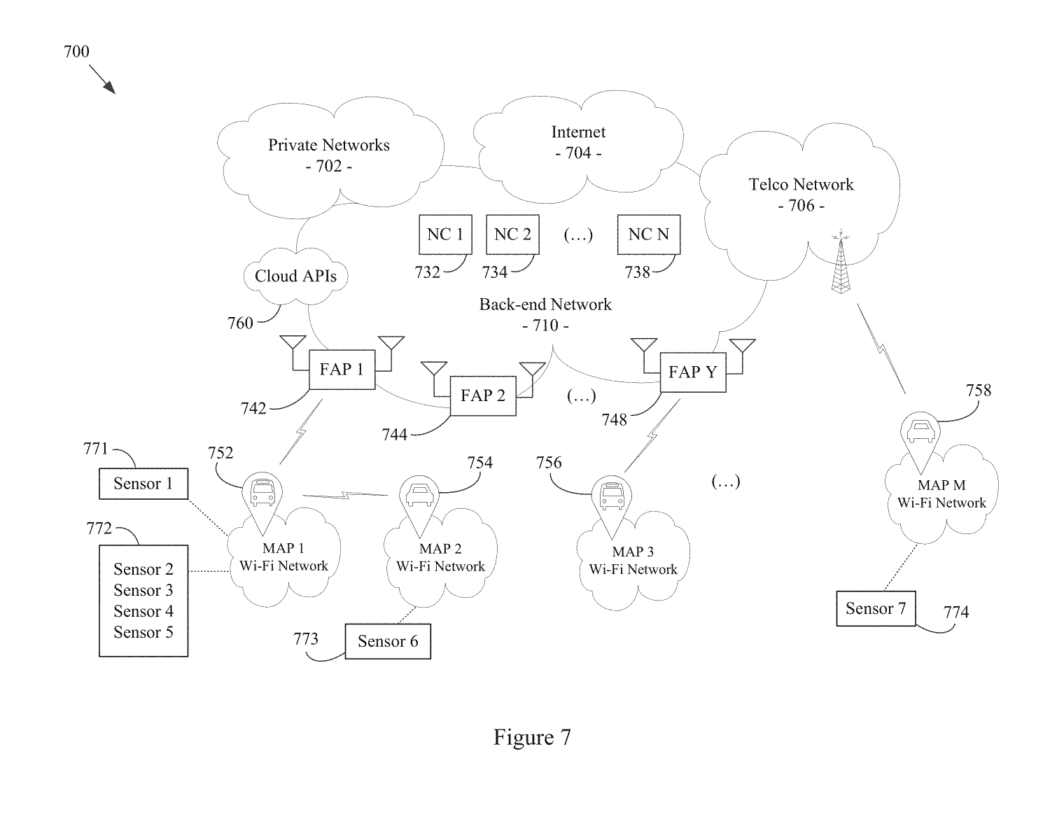

FIG. 7 shows still another block diagram of an example communication network 700, in accordance with various aspects of the present disclosure. The example network 700 may, for example, share any or all characteristics with the other example methods, networks, and/or network components 100, 200, 300, 400, 500-570, 600, 800, 900, 1000, 1100, 1200, 1300 and 1400 discussed herein.

The example network 700 comprises a plurality of vehicles (or Mobile APs, or OBUs), each communicatively coupled to a Fixed AP (or RSU), where each Mobile AP may provide network access to a vehicle network (e.g., comprising other vehicles or vehicle networks, user devices, sensor devices, etc.), for example a Wi-Fi network to which end user devices may connect, with which communication with sensors may be performed, etc. The Mobile APs may, for example move in and out of communication range of various sensors. The Mobile APs may, for example when in-range of such sensors, gather information from such sensors in a power-efficient and network-efficient manner, many examples of which are provided herein.

In particular, the example network 700 shows a plurality of vehicles (or Mobile APs, or MAPs, or OBUs) 752, 754, 756, and 758, each communicatively coupled to a Fixed AP (or RSU) 742, 744, and 748 and/or a cellular network 706, where each Mobile AP may provide network access to a vehicle network (e.g., comprising other vehicles or vehicle networks, user devices, sensor devices, etc.), for example a Wi-Fi network to which end user devices may connect, with which communication with sensors may be performed, etc. The example network 700 may also, for example, comprise a plurality of Network Controllers 732, 734, and 738 (which may also be referred to herein as Mobility Controllers or LMAs). The example network 700 may also, for example, comprise any of a variety of interconnected networks (e.g., Private Networks 702, the Internet 704, Telecommunication Networks 706, etc.). One or more servers of the Cloud may, for example, be accessible via Cloud APIs 760.

The Mobile APs 752, 754, 756, and 758 may, for example, be communicatively coupled to various sensors (e.g., always, as the Mobile APs travel within range of such sensors, etc.). For example, in the example scenario shown in FIG. 7, a first MAP 752 is communicatively coupled to a first sensor 771 (e.g., Sensor 1) and a set of sensors 772 (e.g., Sensor 2, Sensor 3, Sensor 4, and Sensor 5), which may for example be co-located; a second MAP 754 is communicatively coupled to a sixth sensor 773; and an M^{th} MAP 758 is communicatively coupled to a seventh sensor 774. The Mobile APs may, for example move in and out of communication range of the various sensors. The Mobile APs may, for example when in-range of such sensors, gather information from such sensors in a power-efficient and network-efficient manner, many examples of which are provided herein.

A primary goal of the Network of Moving Things (NMT) is to improve the quality of life of the people, and/or the logistics and operations of fleets, vehicles and enterprises that take advantage of it. As such, it is advantageous for the network to enable the end users to actively participate and provide feedback to the entities managing the network, so that the network can be adapted and updated to meet the needs and requirements of those end-users. As discussed herein, such adaptation may be performed in real-time when needed, or may be deferred and scheduled for an appropriate time.

A system deployed on top of the Network of Moving Things (e.g., a network management system, service providing system, etc.) may, for example, acquire various user inputs (e.g., user feedback regarding network performance or quality of service experience, suggestions, opinions, etc.) from the end-users. Such acquisition may, for example, be managed or performed in any of a variety of devices, nodes, or servers (e.g., the user devices, Mobile APs, Fixed APs, Mobility Controllers, Network Operations Center, any of a variety of cloud applications, etc.). Acquired user input information may, for example, be processed at any point in the network. Also for example, acquired user input information may be communicated to the Cloud (e.g., any one or more of a variety of applications running on networked servers, etc.).

The user inputs (or feedback) may comprise any of a variety of characteristics (e.g., qualitative or quantitative). The user inputs may be acquired using any of a variety of types of user input features (e.g., web forms, questionnaires, local GUIs of end-user devices, surveys, etc.). The acquisition of the user inputs may be triggered by any of a variety of causes or conditions (e.g., an unacceptable QoE level, a detected problem in an application, service, captive portal, Web interface, local feedback page, etc.).

A system deployed on top of the Network of Moving Things (e.g., a network management system, service providing system, etc.) may, for example, process the inputs received by the end-users in a optimized way, for example correlating such inputs with other types of information (e.g., other user input information, network performance metric information automatically gathered in the network, etc.) to derive conclusions with regard to network performance, maintenance, and/or adaptation. For example, based at least in part on the user inputs, the system (e.g., a network management system, service providing system, etc.) may take any of a variety of actions on the network or components thereof. Such action may, for example, be performed or initiated locally or at the Cloud-level, either in real-time or following a learning-based approach, etc. Thus, a system deployed on top of the Network of Moving Things (e.g., network management system, service providing system, etc.) constantly updates and adapts the network and/or service providing to meet the requirements and needs of the end-users.

Various aspects of the present disclosure provide for the end-users to become part of a system (e.g., a network management system, service providing system, etc.) built on top of the Network of Moving Things, thus providing for the network and/or service to be constantly updated, improved, and optimized based, at least in part, on inputs from the end-users. The system may, for example, respond automatically (and/or semi-automatically with human oversight) to the user inputs to adapt the system (or any service provided thereby) to meet user needs. The utilization of user input (or feedback) information provides for the quick detection of network problems, and thus for quick action when a network problem is detected. The utilization of such information also provides for learning the levels of quality experienced by the end-users, which is often difficult to determine based on automated system metric acquisition alone.

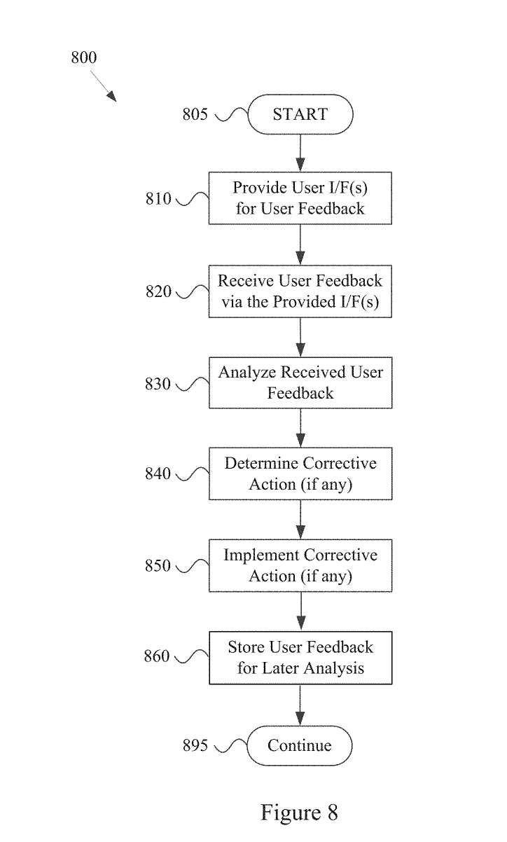

Referring now to FIG. 8, such figure shows a flow diagram of an example method 800 of adapting a network of moving things based at least in part on user feedback, in accordance with various aspects of the present disclosure. The example method 800 may, for example, share any or all characteristics with the other example methods, networks, and/or network components 100, 200, 300, 400, 500-570, 600, 700, 900, 1000, 1100, 1200, 1300 and 1400 discussed herein. For example, any or all functions discussed with regard to the example method 800 may be implemented by one or more of the network nodes discussed herein.

The example method 800 begins executing at block 805. The example method 800 may begin executing in response to any of a variety of causes or conditions, non-limiting examples of which are presented herein.

For example, the example method 800 may generally continually execute, for example in response to powering up, rebooting, or resetting one or more nodes of the network. Also for example, the example method 800 may begin executing in response to a user command (e.g., an end-user request, a command from network management personnel, a service provider request, a fleet manager request, etc.). Additionally for example, the example method 800 may begin executing in response to one or more metric measurements performed automatically by the system (e.g., node or path throughput measurements, error rate measurements, user count or loading measurements, node-generated error or warning messages, etc.). Further for example, the example method 800 may begin executing in response to detecting a user (or particular user) logging into, using and/or logging off of the network. Still further for example, the example method 800 may be initiated statistically (e.g., randomly, directed to potential problem areas of the network at particular times, directed to users situated similarly to another user who has registered a complaint or noted inadequate network performance (e.g., users utilizing a same communication service, a same application, a same device, a same MAP, traveling on a same bus, utilizing the vehicle communication network in a similar manner, etc.), etc.). Also for example, the example method 800 may be initiated periodically (e.g., at timed intervals, consistent and/or inconsistent timed intervals, etc.). In general, the example method 800 may execute in response to any of a variety of causes or conditions. Accordingly, the scope of this disclosure should not be limited by characteristics of any particular cause or condition.

The example method 800 may, at block 810, comprise providing one or more user interfaces (I/F) by which a user may provide feedback or other types of input.

Such user input (or feedback) may comprise any of a variety of characteristics. For example, such input may be quantitative or qualitative (e.g., user specification of a numeric level of satisfaction or Quality of Experience (QoE); user specification of a numeric level of network speed or latency; user specification of satisfaction or dissatisfaction of the network or service performance, user notification of a current service interruption and/or user specification of a number of service interruptions during a session or period of time; user entry of node and/or location identification information; user identification of a service that is performing poorly, user identification of an application or user device type; user specification of time information; user input of vehicle identification information; user input of route information; user identification of desired features or services that are not presently provided; user suggestions for general network improvements; user general complaints; etc.).

Block 810 may comprise providing any of a variety of types of user interfaces. For example, block 810 may comprise providing a user with a graphical user interface on a display, an automated telephone interactive interface, etc. Block 810 may comprise providing a plurality of different types of user interfaces, for example depending on the user's specific utilization of the network (e.g., service-specific interfaces, user device-specific interfaces, problem-specific interfaces, etc.).

Block 810 may comprise providing the user interfaces in any of a variety of manners. For example, block 810 may comprise downloading an app to be executed on a user device, or triggering execution of an app (or portion thereof) that has already been downloaded to the user device. Also for example, block 810 may comprise providing the user with a user interface on a web page (e.g., an Internet or Cloud-based web page). Additionally for example, block 810 may comprise utilizing instant message or texting functionality to interact with the user. Further for example, block 810 may comprise providing the user interface as part of a captive portal. Still further for example, block 810 may comprise executing a user interface application (or portion thereof) on a network node (e.g., a Mobile AP, Fixed AP, Mobility Controller, etc.) that communicates user interface information with the user's device. Also for example, block 810 may comprise calling the user or receiving a call from the user (e.g., a cellular call, VoIP call, etc.). Additionally for example, block 810 may comprise emailing the user to initiate communication with the user (e.g., by user return email, by user selection of a hyperlink, by user selection of a phone number, etc.).

The device on which the interface is provided may comprise any of a variety of characteristics. For example, the device may comprise a general user device (e.g., smart phone, laptop computer, desktop computer, media presentation device, gaming device, smart watch, etc.). Also for example, the device may comprise a user interface device dedicated to a fleet purpose (e.g., driver display on a public transportation vehicle, display on a shipping vehicle, freight delivery vehicle display, forklift display, harbor boat display, road maintenance vehicle display, taxi cab display, waste management vehicle display, navigation display, etc.).

Block 810 may comprise providing the user interface to the user in response to any of a variety of causes or conditions. For example, block 810 may comprise providing the user interface to the user in response to any of the example causes or conditions discussed herein with regard to block 805.

Note, that the example method 800 (e.g., at block 810 or elsewhere) may comprise providing incentives for the users to participate in providing network performance information. For example, the method 800 may comprise providing a discount to users that participate in providing feedback at least a threshold number of times during a time period.

In general, block 810 may comprise providing one or more user interfaces by which a user may provide feedback or other types of input. Accordingly, the scope of this disclosure should not be limited by characteristics of particular types of user interfaces, of particular manners of providing user interfaces, particular causes or conditions that may trigger providing a user interface, etc.

The example method 800 may, at block 820, comprise receiving user input (or feedback) via the provided interfaces. Block 820 may comprise receiving the user input (or feedback) in any of a variety of manners, non-limiting examples of which are provided herein.

For example, block 820 may comprise receiving the user input information at one or more of any of a variety of locations. For example, block 820 may comprise receiving the user input information at a Network Operations Center (NOC) and/or network dashboard. Examples of various NOC user interfaces (and other user interfaces) may, for example, be found in U.S. Provisional Application No. 62/222,150, filed Sep. 22, 2015, and titled “Systems and Method for Interfacing with a User of a Network of Moving Things,” the entire contents of which is hereby incorporated herein by reference. Note that although various examples presented herein are discussed in the context of a Network Operations Center (NOC), the scope of such examples and of this disclosure is not limited thereto. For example, any of the nodes and/or modules discussed herein (e.g., Cloud server(s), Network Controller(s), Fixed AP(s), Mobile AP(s), etc.) may be utilized instead of or in addition to the NOC.

Also for example, block 820 may comprise receiving the user input (or feedback) information at a Cloud (or Internet) server (or application executing thereon, for example a dashboard application) managing a service being provided over the network. Additionally for example, block 820 may comprise receiving the user input information at any node of the network. In an example implementation, there may be issues that are local to a low-level network node, where such low-level network node may comprise diagnostic and/or fault recovery capabilities for various issues.

Block 820 may comprise receiving the user input (or feedback) information via any of a variety of communication pathways. For example, block 820 may comprise receiving the user input information via a same communication pathway through which a service related to the user input is being provided. Also for example, block 820 may comprise receiving the user input information via a communication pathway different from a service related to the user input. In an example scenario, block 820 may comprise receiving user input (or feedback) information related to a VoIP issue provided via the vehicle network, and receive it via a cellular link. In another example scenario, block 820 may comprise receiving user input information related to discontinuities in media being presented via the vehicle network, and receive it via a Wi-Fi hotspot by which the user passes. In still another example scenario, block 820 may comprise receiving user input information related to an inability to log into the vehicle network, via the user's home network.

Note that block 820 may comprise receiving the user input (or feedback) information in real-time as the user enters such information or in a delayed manner (e.g., when a connection becomes available, when convenient for the user, etc.). For example, in an example scenario, an end-user device (or any other network node) may store user input information until a communication pathway between the end-user device (or other node) to the destination for such information becomes available.

Block 820 may, for example, comprise soliciting user input from targeted users that are similarly situated to one or more users from which feedback has already been received. For example, block 820 may comprise determining one or more targeted users that are using a same communication service as one or more users from which feedback has already been received, or that are using a same application, that are using a same device, that are using the vehicle communication network in a generally same manner, that are using the same Mobile AP and/or Fixed AP, that are using a same set of Mobile APs and/or Fixed APs, that are traveling in a same vehicle, that are located in a same geographical area, etc. Block 820 may also comprise soliciting the user input from the targeted users by providing a user interface to such users that is customized to one or more network conditions of interest, for example to minimize the amount of time that a user is utilized to provide useful information.

In general, block 820 comprises receiving user input (or feedback) information via the provided interfaces. Accordingly, the scope of this disclosure should not be limited by characteristics of any particular manner of receiving such information nor by any particular characteristics of such received information.

The example method 800 may, at block 830, comprise analyzing the received user input (or feedback) information. Block 830 may comprise performing such analyzing in any of a variety of manners, non-limiting examples of which are provided herein.

Block 830 may, for example, comprise analyzing the received user feedback to determine the severity (or potential severity) of a network or service issue.

Block 830 may, for example, comprise analyzing other information (e.g., information received from other users, information received from routine and/or targeted network or service monitoring, etc.) to verify a problem (e.g., an adverse network condition, etc.) indicated by the user.

Block 830 may, for example, comprise analyzing network metric information that has already been received (e.g., in status update messages, status response messages, etc.), for example to determine whether there is a correlation between the user feedback and automatically monitored network performance metrics. In an example scenario, recently obtained information regarding a potentially overloaded network node (e.g., Mobile AP, Fixed AP, etc.) and/or other adverse network condition may be utilized to confirm a user-identified problem.

Block 830 may also, for example, comprise analyzing the received user feedback to automatically initiate network-probing (or status request) activity. For example, user feedback indicative of an unavailable connection to a Mobile AP (or other adverse network condition) may cause the initiation of a status request message to the Mobile AP to determine whether the Mobile AP is functioning property. Also for example, a request may be sent to the Mobile AP for information regarding recent log-in attempts may be sent to determine why the user's log-in attempt failed. Additionally for example, user feedback indicative of interruptions in a streaming data service (or other adverse network condition) may cause the initiation of a status request message to any one or more nodes in the communication pathway over which the streamed data is communicated, for example to determine whether any link along the communication pathway is too congested.

Block 830 may, for example, comprise analyzing the received user feedback to generate additional information requests for the user. For example, block 830 may comprise operating in accordance with an expert system, requesting additional information from the user, as block 830 proceeds to identify the network issue.

Block 830 may, for example, comprise determining whether immediate corrective or remedial action is needed. For example, particular problems (e.g., complete node failure) may necessitate immediate action. In such scenarios, block 830 may comprise automatically bringing redundant failover systems on line, immediately dispatching field technicians, remotely rebooting a node, automatically rerouting communications through different pathways in the vehicle network and/or through different networks like cellular, Wi-Fi, satellite, etc.

In a scenario in which a problem is detected, but in which immediate remedial action is not necessary, block 830 may comprise scheduling maintenance activity to investigate and/or fix the detected problem. In an example scenario in which a node is performing adequately but not as well as expected, block 830 may comprise scheduling the node to be rebooted during a period of low expected utilization.

Note that block 830 may comprise performing immediate action and delayed action. For example, in an example scenario in which a network node has failed, block 830 may comprise immediately bringing a redundant failover node on-line, and then scheduling a field service technician to replace the failed node within the next day or two.

Block 830 may, for example, comprise determining that immediate action need not be performed and that maintenance activity need not be immediately ticketed or scheduled, but that there is still a potential problem with the network. In such case, block 830 may determine to continue monitoring the situation (e.g., activating monitoring daemons, etc.), either automatically and/or by waiting for additional user feedback.

Block 830 may, for example, comprise interacting with one or more network and/or service management personnel during the analyzing. For example, block 830 may comprise providing the received user feedback information, information of automatically obtained network performance information, results or conclusions of automatically performed analysis, etc., to a person for verification. For example, in a scenario in which block 830 determines that a node has failed and/or is performing at a low-enough level to warrant immediate corrective action, block 830 may comprise presenting a recommendation to a person (e.g., on a screen of a Network Operations Center, dashboard, etc.) for final approval. Similarly, in a scenario in which block 830 determines that the problem is not critical, but important enough to ticket (or request) a maintenance visit by a technician, block 830 may comprise presenting a recommendation to a person for final approval. Note that such human interaction may be based on severity, for example with only relatively high priority issues being brought to the attention of a human controller, while relatively low priority issues are not.

In general, block 830 may comprise analyzing the received user input (or feedback) information. Accordingly, the scope of this disclosure should not be limited by any particular manner of performing such analyzing.

The example method 800 may, at block 840, comprise determining a corrective (or remedial) action to take. Block 840 may comprise performing such determining in any of a variety of manners, non-limiting examples of which are provided herein.

As discussed herein, corrective actions may comprise automatically switching in redundant failover apparatus, automatically rebooting or resetting network components, automatic rerouting of communication pathway(s) and/or establishing alternative communication links, utilizing alternative networks, immediately dispatching field service personnel, scheduling or ticketing (or requesting) a service call to a particular site, no immediate corrective action but continued and/or enhanced surveillance, obtaining information from alternative sources, etc. Block 840 may, for example, comprise selecting the corrective action to take based on the problem, and/or severity thereof, identified at block 830.

Note that as with other portions of the example method 800, corrective actions may be subject to final approval by a person, but need not be.

In general, block 840 may comprise determining a corrective (or remedial) action to take. Accordingly, the scope of various aspects of this disclosure should not be limited by characteristics of any particular type of corrective action, or by any particular manner of determining such corrective action.

The example method 800 may, at block 850, comprise implementing the corrective (or remedial) action determined at block 840. Block 850 may comprise performing such implementing in any of a variety of manners, depending on the corrective action.

Block 850 may, for example, comprise generating signals to control remote equipment (e.g., provisioning commands, shut down commands, reboot or reset commands, changeover commands, etc.), generating signals to request or schedule technician activity (e.g., job ticket generation, schedule generation, message generation, email generation, phone call generation, etc.), generating messages to request network or service performance information from any one or more nodes in the network, generating requests for more user information, etc.

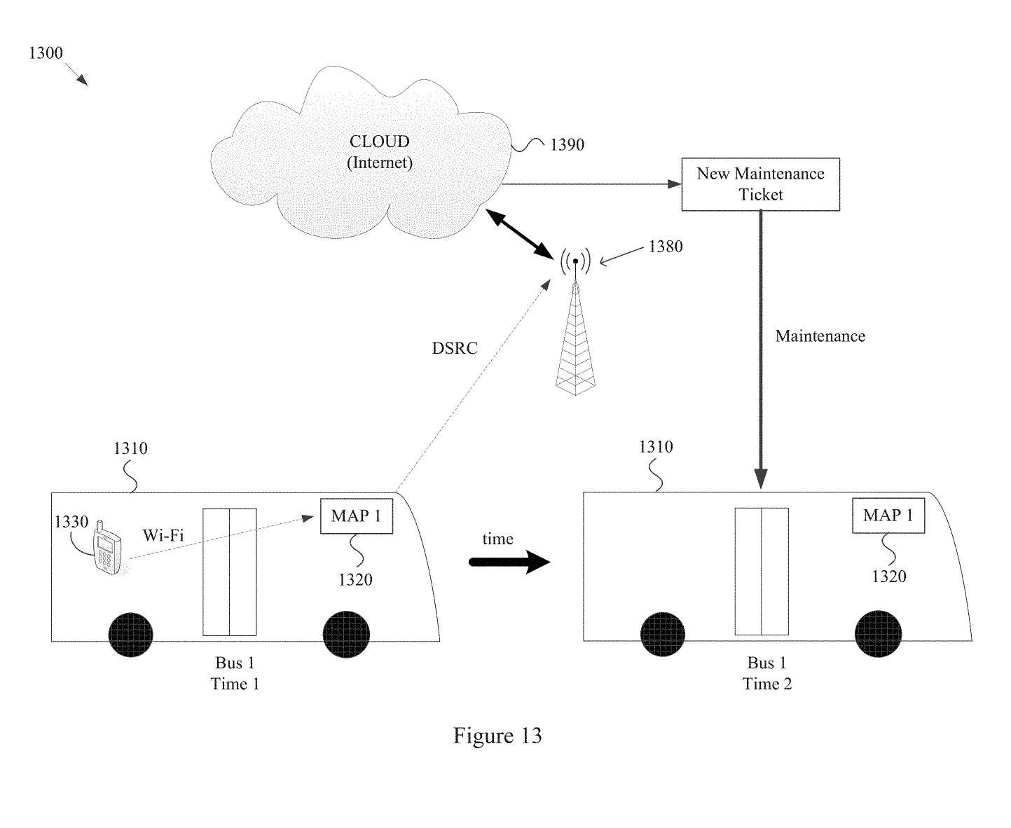

FIG. 13 illustrates an example scenario, in which user feedback from a user on a bus 1310 (e.g., or a truck, watercraft, aircraft, taxi, autonomous vehicle or manually operated vehicle, etc.) is provided via a user device 1330, Mobile AP 1320, DSRC link, Fixed AP 1380, etc., to a NOC or other entity on the Cloud. In the example scenario, the user feedback causes issuance of a Maintenance Ticket, which will cause a field technician to perform Maintenance on the bus 1310 at a later time (e.g., at a bus depot overnight). For example, the user feedback may have been determined to be indicative of a Mobile AP issue.

The example method 800 may, at block 860, comprise storing the user input (or feedback) for later analysis. For example, such information may be stored for the identification of future problems (e.g., combined with additional information obtained in the future), for performing post-mortem analysis, etc.

For example, various types of user input may be indicative of an issue of relatively low importance, and thus be flagged for later study and/or continued monitoring, for example when other user input information is available, when a particular amount of time has been allotted for the acquisition of such information, etc. In an example scenario, the user feedback information (or information descriptive thereof) may be stored for future statistical analysis (e.g., trend or control chart analysis, etc.).

The example method 800 may continue execution at block 895. Such continued execution may comprise any of a variety of characteristics. For example, block 895 may comprise returning execution flow to any previous block. Also for example, block 895 may comprise generating problem and/or problem resolution reports, maintenance records, etc. Additionally for example, block 895 may comprise acknowledging the user feedback, for example communicating to the user regarding the user feedback and/or remedial measures taken or planned, etc.

The example method 800 or any portion thereof may be implemented in one or more nodes of the network. For example, the method 800 or any portion thereof may be implemented in a Cloud (or Internet) server (e.g., in one or more applications). Also for example, the method 800 may be implemented in a distributed fashion with applications executing on at least two of any of the nodes discussed herein.

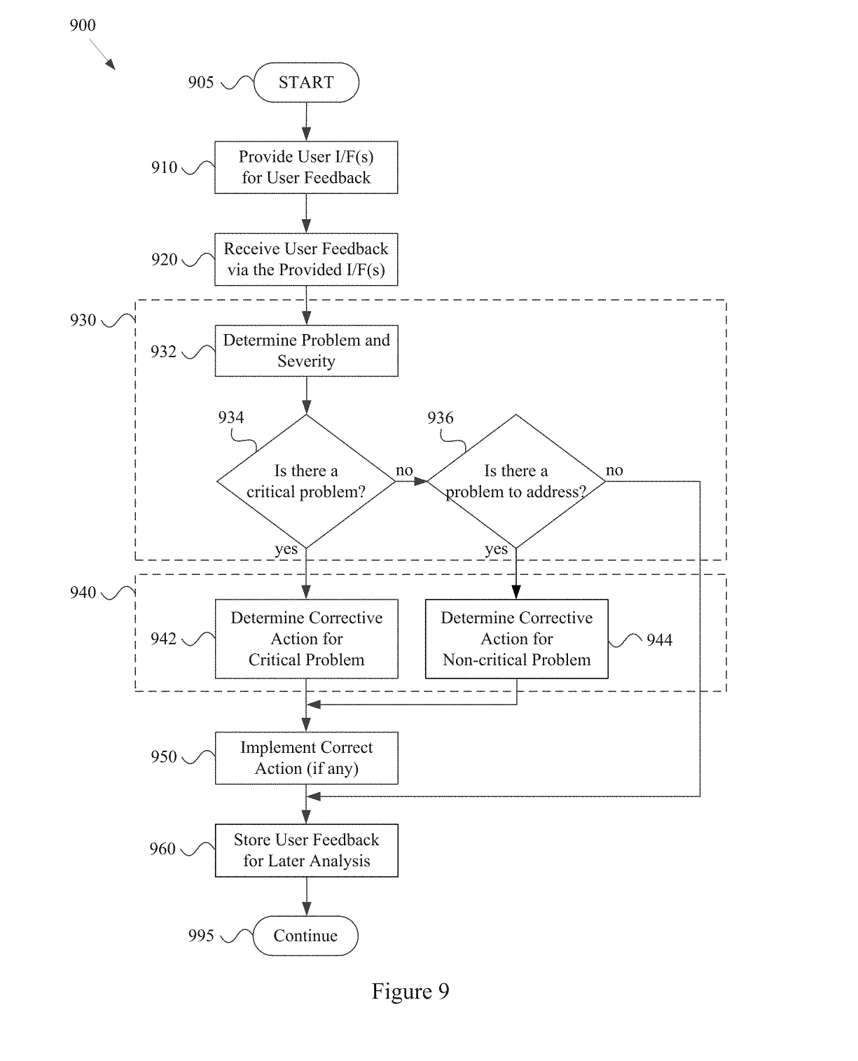

FIG. 9 shows a flow diagram of an example method 900 of adapting a network of moving things based at least in part on user feedback, in accordance with various aspects of the present disclosure. The example method 900 may, for example, share any or all characteristics with the other example methods, networks, and/or network components 100, 200, 300, 400, 500-570, 600, 700, 800, 1000, 1100, 1200, 1300 and 1400 discussed herein. For example, any or all functions discussed with regard to the example method 900 may be implemented by one or more of the network nodes discussed herein.

Blocks 905, 910, 920, 930, 940, 950, 960, and 995 of the example method 900 may, for example, share any or all characteristics with blocks 805, 810, 820, 830, 840, 850, 860, and 895, respectively, of the example method 800 of FIG. 8.

The example method 900 may, at block 930 comprise analyzing the received user input (or feedback) information. In the example shown, block 932 may for example comprise determining a problem (e.g., a network problem, a service problem, etc.), if one exists, and determining a severity of such problem. If the problem is a critical problem (e.g., a problem in need of immediate corrective action, etc.), flow control block 934 may direct execution flow of the example method 900 to block 942 for determining the appropriate corrective action. If the problem is not a critical problem but warranting corrective action, flow control block 936 may direct execution flow of the example method 900 to block 944 for determining the appropriate corrective action. If block 932 determines that there is either not a problem or that there is a potential problem for which more observation and/or analysis is required, flow control blocks 934 and 936 may direct execution flow of the example method 900 to block 960, at least temporarily bypassing corrective action.

As with the example method 800, the example method 900 or any portion thereof may be implemented in one or more nodes of the network. For example, the method 900 or any portion thereof may be implemented in a Cloud (or Internet) server (e.g., in one or more applications). Also for example, the method 900 may be implemented in a distributed fashion with applications executing on at least two of any of the nodes discussed herein.

Network clients and/or end-users may be exposed to (and/or participate in) the service(s) provided at different levels. For example, as clients, they may manage the service through the Network Operations Center (NOC) (or other server, application, etc.) where they will be able to monitor a fleet status, provide a set of orders, and access the service metrics. Also (and/or alternatively) they might just be using the service as regular end-users (e.g., Wi-Fi end users, etc.). Services to which clients and/or end-users are exposed may, for example, comprise: Local Content, Network Operations Center, Internet Access, Captive Portal, and Local Screen Announcements (e.g., of fleets, etc.).

By providing an interactive service, the gap between the Vehicle Network and the Client/Customers may effectively be shortened by providing communication methods (e.g., for user feedback, etc.) across the service being provided. For example, the network solution may automatically recover, by leveraging proximity between the various network components.

Example information about each type of service that may, for example, be used for the system improvement comprises: opinion/feedback from the user (e.g., features and/or services that the user would like to have, statistics, new captive information, etc.), feedback based on the context and experienced levels of QoE (e.g., services in moving or parked vehicles, services within regions of the city, etc.), feedback regarding problems with different types of devices (e.g., smart phones, tablets, laptops, media players, gaming devices, etc.).

Various aspects of the present disclosure will now be presented in reference to a variety of example scenarios. It should be understood that any or all of the example user inputs, manner of obtaining such inputs, manner of analyzing such inputs, manner of responding to such user inputs, etc., may be incorporated in the example methods 800 and 900 discussed herein.

In a first example scenario involving Internet Access Service, a user is travelling and suddenly the connection becomes bad. Additionally, the sudden connection deterioration repeats every time the vehicle arrives at a specific region. In such a scenario, the user may for example communicate a notification of the event to the Mobile/Fixed AP (and thus anywhere in the Cloud) by opening the captive portal page, which may provide for storing the notification information locally. Also, the AP may direct the user feedback to the Cloud, for example for analysis, action, storage, and/or to maintain a historical record, etc.

In an example scenario, when the Mobile AP (or the Cloud) receives a set of alerts at approximately the same time and related to poor service in a specific region, a different captive portal may be presented (e.g., comprising different information and/or user input fields than the normally-presented captive portal).

In a second example scenario involving Internet Access Service, the Cloud (e.g., an application executing on a server in the Cloud) determines that there are a lot of bad ratings of the service provided in a specific region (e.g., more than an acceptable threshold within a particular amount of time, etc.). The Cloud may, for example, make this determination based on received user feedback. In an example implementation, a user may for example have the opportunity to rate the user's last connection when the user logs in at the captive portal (e.g., in a scenario in which the user has not already provided such a rating).

The system may then take any of a variety of remedial steps, depending on the nature of the issue. For example, if the problem is related to DSRC, the Mobile AP(s) may for example redirect traffic to communication pathways utilizing alternative communication technologies (e.g., cellular, Wi-Fi, Bluetooth, etc.), or vice-versa. Such action may at least, for example, be taken until the issue is resolved. Also for example, if the problem is a hardware problem (e.g., with regard to a node in the network, etc.), a notification may be immediately communicated to the Cloud, for example utilizing automated diagnosing/monitoring capabilities. Additionally for example, there may be region-aware limitations of the Internet Access in which positioning information (e.g., GPS information, etc.) is important. In an example scenario, a ticketing system may be implemented, for example when there are more than a threshold number of tickets related to a particular problem, a specific intervention on the relevant node (e.g., Mobile AP, Fixed AP, etc.) may be scheduled.

In a third example scenario involving Internet Access Service, users might not be able to open specific pages and/or users might not be able to access the Internet when using specific devices. In such a scenario, users may, for example, utilize a local feedback page (e.g., on the user's device, on the Mobile AP, etc.) and describe the problem. Such issues may, for example, be related to system compatibility with different web-browsers, firewall functionality, MTU issues related to the transport protocol, etc.

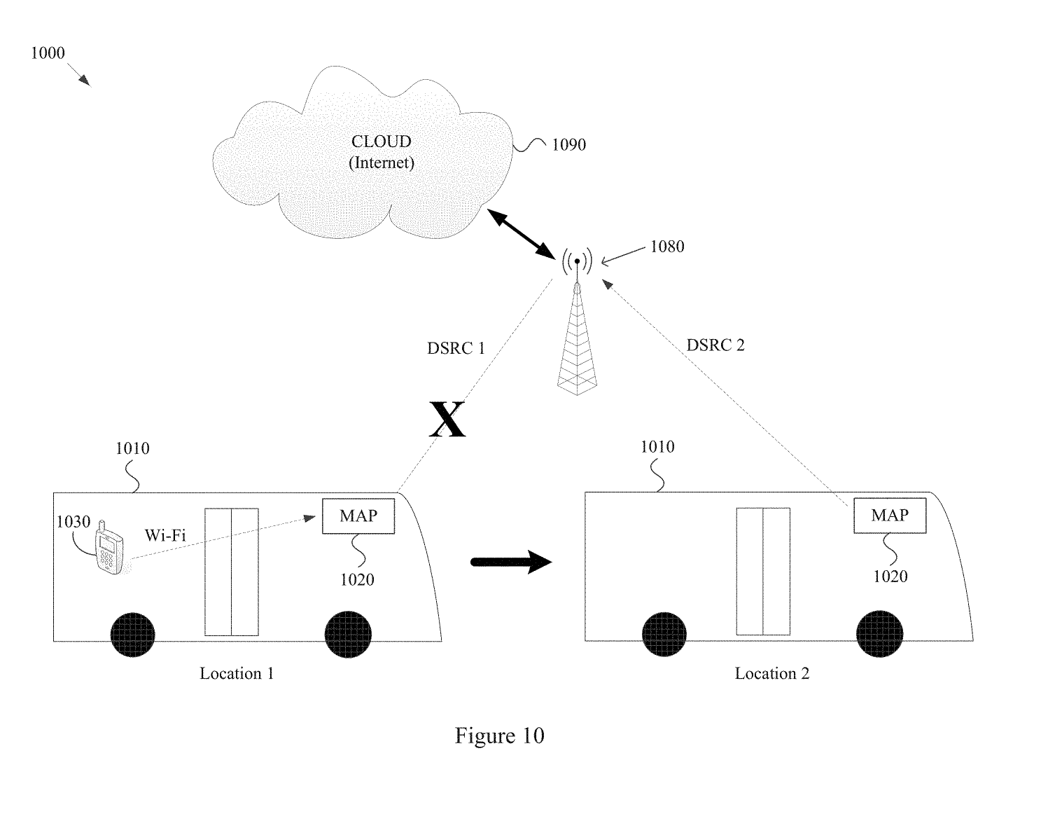

In such a scenario, when the Mobile AP has connectivity, the Mobile AP will send all the stored user feedback to the Cloud, for example for analyzing and taking any necessary actions. This example scenario is shown in FIG. 10, where at Location 1, the user (via user device 1030) communicates user feedback information to the Mobile AP 1020. At Location 1, however, the MAP 1020 does not have an effective DSRC link to the Fixed AP 1080. The MAP 1020 thus stores the user feedback information. At a later time, when the Vehicle 1010 (e.g., a bus, truck, watercraft, aircraft, taxi, autonomous vehicle or manually operated vehicle, etc.) moves to Location 2, the Mobile AP 1020 establishes a communication link DSRC 2 with the Fixed AP 1080 and is thus then able to communicate the stored feedback information to the Cloud 1090 via the Fixed AP 1080.

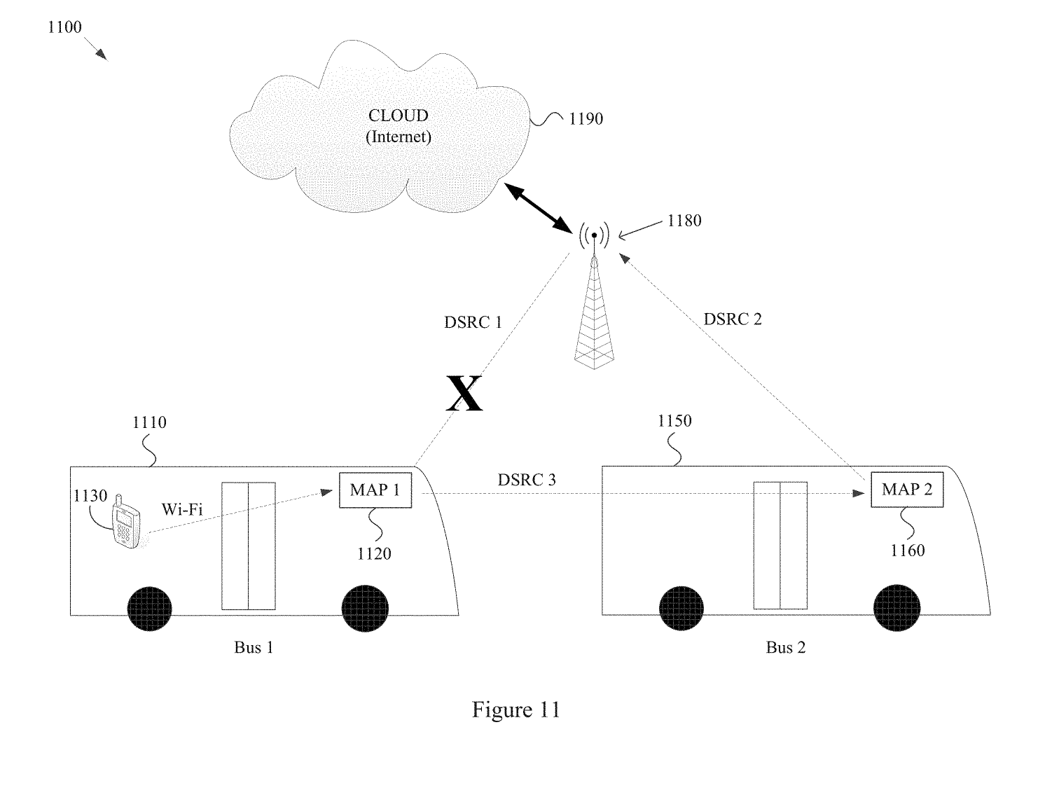

Also for example, the information may be passed through other vehicles that may store the information and communicate such information when able. This example scenario is shown in FIG. 11, where the user (via user device 1130) communicates user feedback information to the first Mobile AP 1120 of the first Bus 1110 (e.g., or truck, watercraft, aircraft, taxi, autonomous vehicle or manually operated vehicle, etc.). The first Mobile AP 1120, however, does not have an effective DSRC link to the Fixed AP 1180. The first MAP 1120 thus communicates the user feedback information to the second MAP 1160 of the second Bus 1150, which has (or will have) an effective DSRC link to the Fixed AP 1180. The second Mobile AP 1160 thus communicates the user feedback information received from the first Mobile AP 1120 to the Cloud 1190 via the Fixed AP 1180.

Additionally, for example in a high-priority situation, alternative communication technologies (e.g., of the Mobile AP or Mobile AP of another vehicle, of the user device, etc.) may be utilized to convey the information to the Cloud (e.g., cellular technology, satellite technology, Wi-Fi technology, etc.).

Note that in scenarios in which particular connectivity issues are related to particular device types, the Cloud may maintain statistics regarding the total number of users utilizing the particular device (or device type). Such information may, for example, be utilized in determining priority of the problem, in determining a remedy for the problem, etc.

In a fourth example scenario involving Internet Access Service, there is a problem with the mobile/Fixed AP unable to provide any type of Internet access through any technology. This is a problem that may, for example, be detected remotely. As a temporary workaround, user devices may for example provide bandwidth through their own cellular data plans and function as temporary backhauls (e.g., to be used by the Mobile AP, Fixed AP, etc.). For example, the network provider may in such a scenario track such bandwidth utilization and reimburse the user(s), who may have registered the cellular connection with the AP.

In a first example scenario involving Local Content Service, the user might not be receiving local content, or for example the received information may be outdated, or for example the received information may be for the wrong geographic region, etc. In such a scenario, the user may utilize a feedback page or a captive portal to provide feedback (e.g., specifying that the content is incorrect, how the content is incorrect, etc.).

For example, this type of problem may be due to a GPS failure at the Mobile AP (e.g., an antenna failure, signal obstruction, etc.). The system may respond to such user feedback by, for example, automatically utilizing GPS information (and/or cellular A-GPS information, etc.) from user devices that are connected to the Mobile AP. The user devices may, for example, share positioning information with the Mobile AP to address the issue. In an example scenario, an alert may also be generated at the Network Operations Center.

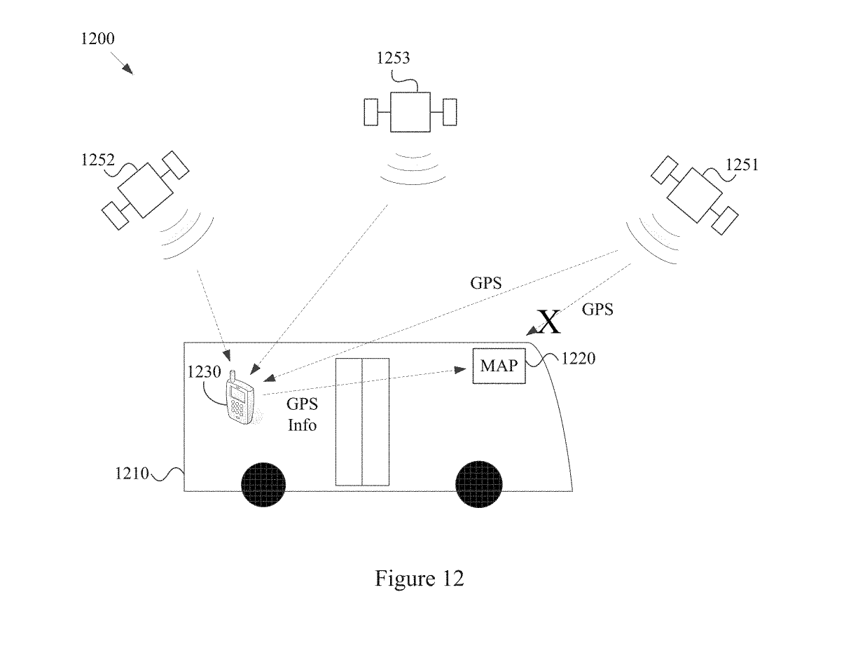

FIG. 12 provides an example illustration of this scenario, in which the GPS signal(s) to the Mobile AP 1220 of the vehicle 1210 (e.g., a bus, truck, watercraft, aircraft, taxi, autonomous vehicle or manually operated vehicle, etc.) from at least the first satellite 1251 are blocked, while GPS signals from first 1251, second 1252, and third 1253 GPS satellites are properly received by the user device 1230. The user device 1230 may (e.g., upon request by the Mobile AP 1220) provide position information (e.g., geolocation information, etc.) to the Mobile AP 1220, which may then be propagated through the network.

In a second example scenario involving Local Content Service, the user may provide service-rating input (or feedback). Such information may, for example, be binary (e.g., positive or negative), a rating on a rating scale (e.g., QoE on a scale of 1 to 10), etc. The user may, for example, send the feedback to the Mobile AP, Fixed AP, Cloud, etc., by opening the captive portal page, which may for example comprise the capability to process and store the feedback locally and/or send the feedback to the Cloud in a cost effective way. The network (or service) owner or provider may then, for example, receive this feedback and based at least in part on such feedback, perform network or service changes to improve operation.

In a third example scenario involving Local Content Service, a user may offer suggestions regarding network improvements or enhancements that the user would like to see. The user may, for example, open the captive portal page, which may comprise the capability to process and/or store the user feedback locally and/or send the feedback to the Cloud in a cost effective manner. The network (or service) owner or operator may then perform network or service modifications based on such feedback.

In a fourth example scenario involving Local Content Service, the user generally detects a problem and may utilize a local feedback page to provide a description of the problem. Such problems may comprise any of a variety of characteristics, for example related to system compatibility with different web-browsers, firewall compatibility issues, MTU issues related to the transport protocol, etc.

In a first example scenario involving Local Screen Announcements, a message is not being correctly displayed. The user may, for example, use a general feedback page or the captive portal to provide feedback regarding the message being incorrect, incorrectly displayed, misdirected, outdated, etc. In this scenario, there may be an issue with regard to the display system belonging to the vehicle owner, who may then be notified by the network operator or service provider (if different from the vehicle owner). In this scenario, there may be an issue with regard to the Mobile AP, in which case the network owner or operator may utilize the Network Operations Center to diagnose and address the issue. In a scenario in which there is an issue with the display and/or vehicle, the network owner or operator may send a message (e.g., from the Network Operations Center, etc.) to the vehicle owner. Note that as with all remedial actions discussed herein, corrective action may be immediate, may be scheduled for a later time, may be suggested or ordered by the formation of a ticket, etc.

In a second example scenario involving Local Screen Announcements, a message is not being displayed at all. The user may, for example, use a general feedback page or the captive portal to provide feedback regarding the message not being displayed. In this scenario, there may be an issue with regard to the display system belonging to the vehicle owner, who may then be notified by the network operator or service provider (if different from the vehicle owner). In this scenario, there may be an issue with regard to the Mobile AP, in which case the network owner or operator may utilize the Network Operations Center to diagnose and address the issue. In a scenario in which there is an issue with the display and/or vehicle, the network owner or operator may send a message (e.g., from the Network Operations Center, etc.) to the vehicle owner. Note that as with all remedial actions discussed herein, corrective action may be immediate, may be scheduled for a later time, may be suggested or ordered by the formation of a ticket, may at least temporarily be put on hold pending further analysis, etc.

In a third example scenario involving Local Screen Announcements, a user would like to use the message advertising system. For example, the user may utilize an SMS-based service to apply for access to and/or utilization of the announcement system. The network owner or operator may, for example, provide for such operation (e.g., under service owner approval).

In a fourth example scenario involving Local Screen Announcements, a user would like to share a video. For example, the user may be provided with RESTful APIs (e.g., available on the local web service provided by the Mobile AP), via which the user can propose the video to the network owner or operator.

In a first example scenario involving a monitoring/management interface of the network or services, a support page (or email) may be provided as an interface between the user and the network owner or operator. For example, the support page may be useful to process and/or filter user input. A user may, for example, rate a request according to the priority (e.g., critical, important but non-critical, moderately important, etc.). In an example scenario, a user may be provided with a set of options, and the user's request can be directed to a specific issue. The network owner or operator may, for example, utilize time windows during which to address various issues (e.g., accordance to relative priority or importance). For example, according to request priority, a ticket may be automatically opened and placed on the queue according to the rating.

In other example scenarios involving a monitoring/management interface of the network or services, a user (or client) might not be able to access the Network Operations Center with the user's login account, there may be a system-rendering incompatibility, there may be missing content, the content might not be acting as expected, etc. In such scenario, the user can advise the network owner or operator through a support email or a support exclusive page. The network owner or operator may then address the issue.

In another example scenario monitoring/management interface of the network or services, a user can provide feedback (e.g., an indication of positive or negative, a rating, suggestions, etc.) through a feedback page. The network owner or operator may then gather the provided feedback and take such feedback into consideration (if positive) or take a responsive action (if negative).

In a first example Captive Portal Operation scenario, the captive portal may ask the user to rate the user's most recent network access experience. For example, the network may already know the details of the user's most recent network access (e.g., vehicle, route, devices utilizes, applications utilized, bandwidth utilized, location(s) during use, etc.), and thus the user need only provide feedback information regarding the user's perceived quality of the experience. This solicitation of user input may be optional or mandatory for the user. For example, incentives may be offered for user participation.

The solicited information may comprise any of a variety of types of information, for example whether the captive portal was adapted to the browser (e.g., smart phone, laptop, tablet, or other device), information regarding Internet access experience, etc. The captive portal may, for example, provide a field in which a user may describe the user's experience in detail (e.g., Quality of Experience (QoE) or quality of service (QoS) when the vehicle was stopped, moving at low speed, moving at high speed, etc.). Note that the user may also provide feedback in real-time, thus providing information by which the system may make immediate decisions, correlate user feedback with location coordinate information, etc.

In a second example Captive Portal Operation scenario, the user may utilize a captive portal interface to request new content. The user may, for example, request new content to be stored as local content. Such content may be tracked, analyzed, and utilized for predictive delivery in the future. For example, a news summary may be proactively downloaded to local memory (e.g., Mobile AP memory) in a scenario in which a substantial number of users were found to repeatedly request such content. Also for example, the system may similarly track first or popular URLs the users utilize. In an example scenario, the Mobile AP can learn user group habits and proactively download and store content (e.g., newspapers, magazines, etc.).

The previous example scenarios were presented for illustrative purposes only and not by way of limitation. The scope of this disclosure should not be limited by characteristics of any of the example scenarios presented herein.

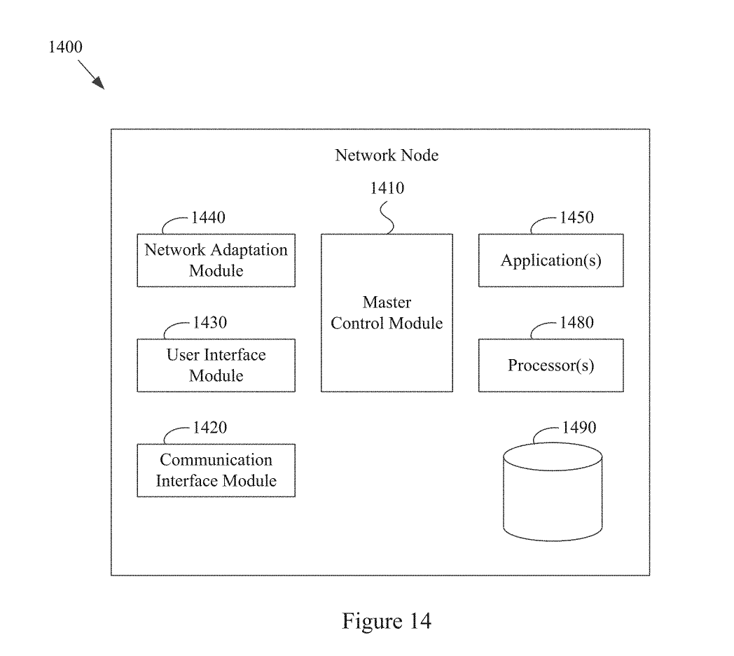

FIG. 14 shows a block diagram of various components of an example network node 1400, in accordance with various aspects of the present disclosure. The example node 1400 may, for example, share any or all characteristics with the other example methods, networks, and/or network components 100, 200, 300, 400 500-570, 600, 700, 800, 900, 1000, 1100, 1200, and 1300, discussed herein. For example, any or all of the components of the example node 1400 may perform any or all of the method steps presented herein.

The example node 1400 may, for example, comprise a user device, Mobile AP, Fixed AP, Mobility Controller, Network Operations Center, Cloud server, Internet Server, client device, etc.

The example node 1400 may, for example, comprise a communication interface module 1420 that operates to perform any or all of the wireless and/or wired communication functionality for the node 1400, many examples of which are provided herein (e.g., communication with MCs, communication with Fixed AP nodes, communication with Mobile AP nodes, communication directly with client devices, backhaul communication, Cloud server communication, etc.). The communication I/F (interface) module 1420 may, for example, operate in accordance with any of a variety of cellular communication protocols, wireless LAN communication protocols (e.g., Wi-Fi, etc.), wireless PAN communication protocols (e.g., Bluetooth, etc.), 802.11p or DSRC, satellite communication protocols, fiber or cable communication protocols, LAN protocols (e.g., Ethernet, etc.), TCP/IP, etc. For example, any of the example communication discussed herein between a user device and a Mobile AP or Fixed AP or other base station, between a Mobile AP and a Fixed AP, between a Mobile AP and an MC, between a Mobile AP and a Fixed or Mobile AP, between a Network Operations Center and any other node, between a Cloud server and any other node, etc., may be performed utilizing the communication interface module 1420.

The example node 1400 also comprises a User Interface Module 1430. The User Interface Module 1430 may, for example, operate to perform any or all of the user interface functionality discussed herein (e.g., at high level network servers, at the user device, at a node implementing captive portal functionality, etc.).

The example node 1400 also comprises a Network Adaptation Module 1440. The Network Adaptation Module 1440 may, for example, operate to perform any or all of the network adaptation functionality discussed herein (e.g., network corrective and/or remedial activity, maintenance scheduling, failover functionality, reboot/reset functionality, network diagnostic functionality, user feedback analysis functionality, corrective action determination and/or implementation functionality, information gathering functionality, etc.).

The example node 1400 may, for example, comprise a Master Control Module 1410 that generally manages operation of the node 1400 at a high level. Such Master Control Module 1410 may, for example, comprise various aspects of an operating system for the node 1400.

The example node 1400 may further, for example, comprise one or more applications 1450 executing on the node 1400 (e.g., client management applications, security applications, power management applications, vehicle monitoring applications, location services applications, user interface applications, etc.).

The example node 1400 may also comprise one or more processors 1480 and memory devices 1490. The processor(s) 1480 may, for example, comprise any of a variety of processor characteristics. For example, the processor(s) 1480 may comprise one or more of a general purposes processor, RIS processor, microcontroller, ASIC, DSP, video processor, etc.). The memory device(s) 1490 may, for example comprise any of a variety of memory characteristics. For example, the memory device(s) 1490 may comprise a volatile memory, non-volatile memory, etc. The memory device(s) 1490 may, for example, comprise a non-transitory computer-readable medium that comprises software instructions that when executed by the processor(s) 1480, cause the node 1400 to perform any or all of the functionality discussed herein (e.g., with regard to the example methods discussed herein, etc.).

In accordance with various aspects of this disclosure, end users, groups of people, fleets, municipalities, etc., that utilize the Network of Moving Things will benefit from the end-user (or client) feedback capabilities provided. Any of a variety of products and/or applications and/or services deployed on top of the Network of Moving Things may be improved in accordance with user feedback. The Network of Moving Things may also be improved based on user feedback. Response time benefits may also be provided while enhancing the user experience at various levels of user interaction with the network (e.g., end-user level, service provider or controller level, network management level, etc.).

Note that the systems and methods discussed herein may be applied independently to a plurality of respective services. By bringing end-users closer to the service with powerful tools for user feedback, the users may provide valuable input, which the service and network adaptation tools provided herein may then leverage to enhance the QoE provided to the users. Additionally, while many aspects of the systems and methods provided herein are generic between services, other aspects are flexibly customizable between different services and their respective challenges, needs, and priorities.

In accordance with various aspects of this disclosure, examples of the networks and/or components thereof presented herein are provided in U.S. Provisional Application Ser. No. 62/222,192, titled “Communication Network of Moving Things,” filed on Sep. 22, 2015, which is hereby incorporated herein by reference in its entirety.

In accordance with various aspects of this disclosure, the networks and/or components thereof presented herein are provided with systems and methods for integrating such networks and/or components with other networks and systems, non-limiting examples of which are provided in U.S. Provisional Application Ser. No. 62/221,997, titled “Integrated Communication Network for A Network of Moving Things,” filed on Sep. 22, 2015, which is hereby incorporated herein by reference in its entirety.

Also, in accordance with various aspects of this disclosure, the networks and/or components thereof presented herein are provided with systems and methods for synchronizing such networks and/or components, non-limiting examples of which are provided in U.S. Provisional Application Ser. No. 62/222,016, titled “Systems and Methods for Synchronizing a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for managing such networks and/or components, non-limiting examples of which are provided in U.S. Provisional Application Ser. No. 62/222,042, titled “Systems and Methods for Managing a Network of Moving Things,” filed on Sep. 22, 2015, which is hereby incorporated herein by reference in its entirety.

Further, in accordance with various aspects of this disclosure, the networks and/or components thereof presented herein are provided with systems and methods for monitoring such networks and/or components, non-limiting examples of which are provided in U.S. Provisional Application Ser. No. 62/222,066, titled “Systems and Methods for Monitoring a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for detecting and/or classifying anomalies in such networks and/or components, non-limiting examples of which are provided in U.S. Provisional Application Ser. No. 62/222,077, titled “Systems and Methods for Detecting and Classifying Anomalies in a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for managing mobility in such networks and/or components, non-limiting examples of which are provided in U.S. Provisional Application Ser. No. 62/222,098, titled “Systems and Methods for Managing Mobility in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for managing connectivity in such networks and/or components, non-limiting examples of which are provided in U.S. Provisional Application Ser. No. 62/222,121, titled “Systems and Methods for Managing Connectivity a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for collecting sensor data in such networks and/or components, non-limiting examples of which are provided in U.S. Provisional Application Ser. No. 62/222,135, titled “Systems and Methods for Collecting Sensor Data in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for interfacing with such networks and/or components, non-limiting examples of which are provided in U.S. Provisional Application Ser. No. 62/222,145, titled “Systems and Methods for Interfacing with a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for interfacing with a user of such networks and/or components, non-limiting examples of which are provided in U.S. Provisional Application Ser. No. 62/222,150, titled “Systems and Methods for Interfacing with a User of a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for data storage and processing in such networks and/or components, non-limiting examples of which are provided in U.S. Provisional Application Ser. No. 62/222,168, titled “Systems and Methods for Data Storage and Processing for a Network of Moving Things,” filed on Sep. 22, 2015, which is hereby incorporated herein by reference in its entirety.

Also, in accordance with various aspects of this disclosure, the networks and/or components thereof presented herein are provided with systems and methods for vehicle traffic management in such networks and/or components, non-limiting examples of which are provided in U.S. Provisional Application Ser. No. 62/222,183, titled “Systems and Methods for Vehicle Traffic Management in a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for environmental management in such networks and/or components, non-limiting examples of which are provided in U.S. Provisional Application Ser. No. 62/222,186, titled “Systems and Methods for Environmental Management in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for managing port or shipping operation in such networks and/or components, non-limiting examples of which are provided in U.S. Provisional Application Ser. No. 62/222,190, titled “Systems and Methods for Port Management in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for enhancing the accuracy of positioning or location information based at least in part on historical data, non-limiting examples of which are provided in U.S. Provisional Application Ser. No. 62/244,828, titled “Utilizing Historical Data to Correct GPS Data in a Network of Moving Things,” filed on Oct. 22, 2015, which is hereby incorporated herein by reference in its entirety.

Additionally, in accordance with various aspects of this disclosure, the networks and/or components thereof presented herein are provided with systems and methods for enhancing the accuracy of position or location of positioning or location information based at least in part on the utilization of anchors, non-limiting examples of which are provided in U.S. Provisional Application Ser. No. 62/244,930, titled “Using Anchors to Correct GPS Data in a Network of Moving Things,” filed on Oct. 22, 2015, which is hereby incorporated herein by reference in its entirety.

Further, in accordance with various aspects of this disclosure, the networks and/or components thereof presented herein are provided with systems and methods for providing communication between applications, non-limiting examples of which are provided in U.S. Provisional Application Ser. No. 62/246,368, titled “Systems and Methods for Inter-Application Communication in a Network of Moving Things,” filed on Oct. 26, 2015, which is hereby incorporated herein by reference in its entirety.

Still further, in accordance with various aspects of this disclosure, the networks and/or components thereof presented herein are provided with systems and methods for probing, analyzing and/or validating communication, non-limiting examples of which are provided in U.S. Provisional Application Ser. No. 62/246,372, titled “Systems and Methods for Probing and Validating Communication in a Network of Moving Things,” filed on Oct. 26, 2015, which is hereby incorporated herein by reference in its entirety.

Yet further, in accordance with various aspects of this disclosure, the networks and/or components thereof presented herein are provided with systems and methods for adapting communication rate, non-limiting examples of which are provided in U.S. Provisional Application Ser. No. 62/250,544, titled “Adaptive Rate Control for Vehicular Networks,” filed on Nov. 4, 2015, which is hereby incorporated herein by reference in its entirety.

Also, in accordance with various aspects of this disclosure, the networks and/or components thereof presented herein are provided with systems and methods for reconfiguring and adapting hardware, non-limiting examples of which are provided in U.S. Provisional Application Ser. No. 62/273,878, titled “Systems and Methods for Reconfiguring and Adapting Hardware in a Network of Moving Things,” filed on Dec. 31, 2015, which is hereby incorporated herein by reference in its entirety.

Additionally, in accordance with various aspects of this disclosure, the networks and/or components thereof presented herein are provided with systems and methods for optimizing the gathering of data, non-limiting examples of which are provided in U.S. Provisional Application Ser. No. 62/253,249, titled “Systems and Methods for Optimizing Data Gathering in a Network of Moving Things,” filed on Nov. 10, 2015, which is hereby incorporated herein by reference in its entirety.

Further, in accordance with various aspects of this disclosure, the networks and/or components thereof presented herein are provided with systems and methods for performing delay tolerant networking, non-limiting examples of which are provided in U.S. Provisional Application Ser. No. 62/257,421, titled “Systems and Methods for Delay Tolerant Networking in a Network of Moving Things,” filed on Nov. 19, 2015, which is hereby incorporated herein by reference in its entirety.

Still further, in accordance with various aspects of this disclosure, the networks and/or components thereof presented herein are provided with systems and methods for improving the coverage and throughput of mobile access points, non-limiting examples of which are provided in U.S. Provisional Application Ser. No. 62/265,267, titled “Systems and Methods for Improving Coverage and Throughput of Mobile Access Points in a Network of Moving Things,” filed on Dec. 9, 2015, which is hereby incorporated herein by reference in its entirety.

Yet further, in accordance with various aspects of this disclosure, the networks and/or components thereof presented herein are provided with systems and methods for coordinating channel utilization, non-limiting examples of which are provided in U.S. Provisional Application Ser. No. 62/270,858, titled “Channel Coordination in a Network of Moving Things,” filed on Dec. 22, 2015, which is hereby incorporated herein by reference in its entirety.

Also, in accordance with various aspects of this disclosure, the networks and/or components thereof presented herein are provided with systems and methods for implementing a network coded mesh network in the network of moving things, non-limiting examples of which are provided in U.S. Provisional Application Ser. No. 62/257,854, titled “Systems and Methods for Network Coded Mesh Networking in a Network of Moving Things,” filed on Nov. 20, 2015, which is hereby incorporated herein by reference in its entirety.

Additionally, in accordance with various aspects of this disclosure, the networks and/or components thereof presented herein are provided with systems and methods for improving the coverage of fixed access points, non-limiting examples of which are provided in U.S. Provisional Application Ser. No. 62/260,749, titled “Systems and Methods for Improving Fixed Access Point Coverage in a Network of Moving Things,” filed on Nov. 30, 2015, which is hereby incorporated herein by reference in its entirety.

Further, in accordance with various aspects of this disclosure, the networks and/or components thereof presented herein are provided with systems and methods for managing mobility controllers and their network interactions, non-limiting examples of which are provided in U.S. Provisional Application Ser. No. 62/273,715, titled “Systems and Methods for Managing Mobility Controllers and Their Network Interactions in a Network of Moving Things,” filed on Dec. 31, 2015, which is hereby incorporated herein by reference in its entirety.

Still further, in accordance with various aspects of this disclosure, the networks and/or components thereof presented herein are provided with systems and methods for managing and/or triggering handovers of mobile access points, non-limiting examples of which are provided in U.S. Provisional Application Ser. No. 62/281,432, titled “Systems and Methods for Managing and Triggering Handovers of Mobile Access Points in a Network of Moving Things,” filed on Jan. 21, 2016, which is hereby incorporated herein by reference in its entirety.

Yet further, in accordance with various aspects of this disclosure, the networks and/or components thereof presented herein are provided with systems and methods for performing captive portal-related control and management, non-limiting examples of which are provided in U.S. Provisional Application Ser. No. 62/268,188, titled “Captive Portal-related Control and Management in a Network of Moving Things,” filed on Dec. 16, 2015, which is hereby incorporated herein by reference in its entirety.

Also, in accordance with various aspects of this disclosure, the networks and/or components thereof presented herein are provided with systems and methods for extrapolating high-value data, non-limiting examples of which are provided in U.S. Provisional Application Ser. No. 62/270,678, titled “Systems and Methods to Extrapolate High-Value Data from a Network of Moving Things,” filed on Dec. 22, 2015, which is hereby incorporated herein by reference in its entirety.

Additionally, in accordance with various aspects of this disclosure, the networks and/or components thereof presented herein are provided with systems and methods for providing remote software updating and distribution, non-limiting examples of which are provided in U.S. Provisional Application Ser. No. 62/272,750, titled “Systems and Methods for Remote Software Update and Distribution in a Network of Moving Things,” filed on Dec. 30, 2015, which is hereby incorporated herein by reference in its entirety.

Further, in accordance with various aspects of this disclosure, the networks and/or components thereof presented herein are provided with systems and methods for providing remote configuration updating and distribution, non-limiting examples of which are provided in U.S. Provisional Application Ser. No. 62/278,662, titled “Systems and Methods for Remote Configuration Update and Distribution in a Network of Moving Things,” filed on Jan. 14, 2016, which is hereby incorporated herein by reference in its entirety.

Still further, in accordance with various aspects of this disclosure, the networks and/or components thereof presented herein are provided with systems and methods for adapting the network, for example automatically, based on user feedback, non-limiting examples of which are provided in U.S. Provisional Application Ser. No. 62/286,243, titled “Systems and Methods for Adapting a Network of Moving Things Based on User Feedback,” filed on Jan. 22, 2016, which is hereby incorporated herein by reference in its entirety.

Yet further, in accordance with various aspects of this disclosure, the networks and/or components thereof presented herein are provided with systems and methods for enhancing and/or guaranteeing data integrity when building or performing data analytics, non-limiting examples of which are provided in U.S. Provisional Application Ser. No. 62/278,764, titled “Systems and Methods to Guarantee Data Integrity When Building Data Analytics in a Network of Moving Things,” Jan. 14, 2016, which is hereby incorporated herein by reference in its entirety.

Also, in accordance with various aspects of this disclosure, the networks and/or components thereof presented herein are provided with systems and methods for performing self-initialization and/or automated bootstrapping of mobile access points, non-limiting examples of which are provided in U.S. Provisional Application Ser. No. 62/286,515, titled “Systems and Methods for Self-Initialization and Automated Bootstrapping of Mobile Access Points in a Network of Moving Things,” filed on Jan. 25, 2016, which is hereby incorporated herein by reference in its entirety.

Additionally, in accordance with various aspects of this disclosure, the networks and/or components thereof presented herein are provided with systems and methods for managing power supply and/or utilization, non-limiting examples of which are provided in U.S. Provisional Application Ser. No. 62/295,602, titled “Systems and Methods for Power Management in a Network of Moving Things,” filed on Feb. 16, 2016, which is hereby incorporated herein by reference in its entirety.

Further, in accordance with various aspects of this disclosure, the networks and/or components thereof presented herein are provided with systems and methods for automating and easing the installation and setup of the infrastructure, non-limiting examples of which are provided in U.S. Provisional Application Ser. No. 62/299,269, titled “Systems and Methods for Automating and Easing the Installation and Setup of the Infrastructure Supporting a Network of Moving Things,” filed on Feb. 24, 2016, which is hereby incorporated herein by reference in its entirety.

In summary, various aspects of this disclosure provide systems and methods for adapting a network of moving things, for example including autonomous vehicles, based at least in part on user feedback. As non-limiting examples, various aspects of this disclosure provide systems and methods for obtaining user feedback, communicating user feedback, analyzing obtained user feedback, and determining and implementing corrective action, for example in a real-time or delayed manner. While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

What is claimed is:

1. A system for use in a vehicle communication network comprising a mobile access point (MAP), the system comprising:
at least one module operable to, at least:
provide a user interface to a user of the MAP;
receive, through the provided user interface, user feedback from the user regarding operation of the vehicle communication network;
identify, based at least in part on the received user feedback, an action to take; and
perform the identified action.

2. The system of claim 1, wherein the at least one module is operable to identify the action to take based also, at least in part, on feedback received from another user.

3. The system of claim 1, wherein the at least one module is operable to identify the action to take based, at least in part, on network metric information received from one or more network nodes before the received user feedback.

4. The system of claim 1, wherein the at least one module is operable to identify the action to take by, at least in part, operating to determine whether to immediately dispatch a field service technician or to schedule maintenance activity.

5. The system of claim 1, wherein the identified action comprises soliciting additional user feedback from one or more other users regarding operation of the vehicle communication network.

6. The system of claim 1, wherein the identified action comprises soliciting additional feedback from the user.

7. The system of claim 1, wherein the identified action comprises:
identifying, based at least in part on the received user feedback, one or more nodes of the vehicle communication network; and
communicating status request messages to the identified one or more nodes.

8. The system of claim 1, wherein the identified action comprises tailoring network monitoring to a portion of the vehicle communication network associated with the received user feedback.

9. The system of claim 1, wherein the identified action comprises storing the received user feedback and designating the received user feedback for later analysis.

10. The system of claim 1, wherein the identified action comprises providing a response recommendation to a human operator.

11. The system of claim 1, wherein the identified action comprises provisioning communication resources of the vehicle communication network to address a network condition associated with the received user feedback.

12. The system of claim 1, wherein a Network Operations Center (NOC) comprises the at least one module.

13. A system for use in a vehicle communication network comprising a mobile access point (MAP), the system comprising:
at least one module operable to, at least:
determine that an adverse network condition may be occurring in the vehicle communication network;
identify at least one target user from whom to solicit user feedback regarding the adverse network condition;
provide, via the MAP, a user interface to the identified at least one target user soliciting the user feedback regarding the adverse network condition; and
receive the user feedback regarding the adverse network condition via the provided user interface and the MAP.

14. The system of claim 13, wherein the at least one module is operable to determine that an adverse network condition may be occurring in the vehicle communication network based, at least in part, on first user feedback received from a first user of the vehicle communication network.

15. The system of claim 14, wherein the at least one module is operable to identify the at least one target user by, at least in part, identifying one or more users that are utilizing the vehicle communication network in a manner similar to the first user.

16. The system of claim 13, wherein the at least one module is operable to identify the at least one target user by, at least in part, operating to:
identify a communication service expected to be impacted by the adverse network condition; and
identify the at least one target user by, at least in part, identifying users utilizing the identified communication service.

17. The system of claim 13, wherein the at least one module is operable to identify the at least one target user by, at least in part, operating to:
identify one or more target mobile access points (MAPs) expected to be impacted by the adverse network condition; and
identify the at least one target user by, at least in part, identifying users utilizing the one or more target MAPs.

18. The system of claim 13, wherein the at least one module is operable to identify the at least one target user by, at least in part, operating to:
identify a geographical area expected to be impacted by the adverse network condition; and
identify the at least one target user by, at least in part, identifying users and/or MAPs operating in the geographical area.

19. The system of claim 13, therein the provided user interface is customized to the adverse network condition.

20. A mobile access point (MAP) comprising:
a wireless transceiver; and
at least one module operable to, at least:
provide a user interface;
receive, through the provided user interface, user feedback regarding operation of the vehicle communication network;
determine, based at least in part on the received user feedback, a manner in which to communicate the received user feedback to another network node; and
communicate the received user feedback to the other network node in the determined manner.

21. The mobile access point (MAP) of claim 20, wherein the determined manner comprises waiting until the MAP is within communication range of a fixed access point (FAP), and then communicating the received user feedback to the other network node via the FAP.

22. The mobile access point (MAP) of claim 20, wherein the determined manner comprises communicating the received user feedback to the other network node via another MAP.

23. The mobile access point (MAP) of claim 20, wherein the at least one module is operable to determine the manner in which to communicate the received user feedback to the other network node by, at least in part, operating to determine whether to communicate the received user feedback to the other network node immediately or in a delay tolerant manner.

24. The mobile access point (MAP) of claim 20, wherein the at least one module is operable to determine the manner in which to communicate the received user feedback to the other network node by, at least in part, operating to determine a priority of the received user feedback.
